(19) United States
(12) Patent Application Publication
(10) Pub. No.: US 2016/0085426 A1
(43) Pub. Date: Mar. 24, 2016

(54) Interactive Imaging System

(71) Applicant: The Boeing Company, Chicago, IL (US)

(72) Inventor: Jeremiah Kent Scott, Kirkland, WA (US)

(21) Appl. No.: 14/490,132

(22) Filed: Sep. 18, 2014

(51) Int. Cl. G06F 3/0484; G06F 17/50; G09G 5/377; G06F 3/0481; G06F 3/0482

(52) U.S. Cl. CPC G06F 3/04847; G06F 3/04812; G06F 3/0482; G06F 3/04842; G09G 5/377; G06F 17/5095; G09G 2354/00; G09G 2380/12; G09G 2340/12

(57) ABSTRACT

A method and apparatus for providing a visual aid in assembling an aircraft. A display for a portion of an aircraft is displayed on a display system in a mobile data processing system. The display on the display system comprises an image of the portion of the aircraft and hot spots over areas of the image. The hot spots correspond to installation plans for the areas over which the hot spots are located and the hot spots are selectable by user input. Information is displayed on the display system in the mobile data processing system about the installation plan for an area in the areas when a hot spot in the hot spots corresponding to the area is selected by the user input. The display of the information on the display system provides a visual aid that enables performance of an assembly operation in the area selected.

### BACKGROUND INFORMATION

1. Field

The present disclosure relates generally to aircraft and, in particular, to manufacturing aircraft. Still more particularly, the present disclosure relates to a method and apparatus for providing a visual aid for assembly processes used to build an aircraft.

2. Background

Manufacturing aircraft, such as commercial aircraft, is a complex process involving the design and assembly of thousands of parts. Many of the parts are assembled to form the assemblies and subassemblies for the aircraft.

Different tasks are assigned operations to perform the assembly of aircraft. These operations may include, for example, putting together parts to form an assembly, inspecting an assembly, or other suitable operations.

For example, inspections are performed as part of the assembly process for the aircraft. The inspections ensure that the aircraft has been assembled in a desired manner, and whether the parts themselves function as desired. These inspections are formed as part of a quality control process in building the aircraft. With the size and number of aircraft, finding a location to perform operations to put parts together for assembly or to inspect an assembly of parts is often a time-consuming and tedious process.

An inspector is assigned to perform an inspection of an assembly. The inspector assigned this task enters and moves within the aircraft to find the location of the assembly for inspection.

Performing an inspection of an assembly may take more time and effort than desired unless the inspector has had experience with inspecting and locating a particular assembly. Additionally, the same model of aircraft may have different options. As a result, one aircraft may have an assembly with a different location from another aircraft. In yet another example, one aircraft may include the assembly while another aircraft does not include the assembly.

With the size of a commercial aircraft and the different options available for a commercial aircraft, the inspection process may be more difficult than desired. Currently, an inspector may have a binder that includes a checklist, inspection criteria, photographs of correct and incorrect installations, and engineering drawings. The inspector uses these materials to locate and perform an inspection of an assembly in the aircraft. These materials, however, do not necessarily provide a good understanding of the location of the assembly in which the inspection is to be performed, when an assembly is correct, or some combination thereof.

The inspector may undergo training to obtain a better understanding of inspections for particular assemblies in an aircraft. Also, as an inspector gains experience in inspecting the same assembly or groups of assemblies, the inspection process becomes faster and easier to perform.

However, when a new assembly is assigned to the inspector, the learning process begins again. As a result, it is often desirable to assign inspections of assemblies to inspectors who have experience with those assemblies. This situation, however, may result in limitations to the manner in which inspectors may be assigned inspection tasks. As a result, performing inspections may not occur as quickly and efficiently as desired.

Therefore, it would be desirable to have a method and apparatus that take into account at least some of the issues discussed above, as well as other possible issues. For example, one technical issue with performing operations in assembling an aircraft is an inability to enable performance of the operations as quickly and efficiently as desired.

### SUMMARY

An illustrative embodiment of the present disclosure provides a method for providing a visual aid in assembling an aircraft. A display for a portion of an aircraft is displayed on a display system in a mobile data processing system. The display on the display system comprises an image of the portion of the aircraft and hot spots over areas of the image. The hot spots correspond to installation plans for the areas over which the hot spots are located and the hot spots are selectable by user input. Information is displayed on the display system in the mobile data processing system about the installation plan for an area in the areas when a hot spot in the hot spots corresponding to the area is selected by the user input. The display of the information on the display system provides a visual aid that enables performance of an assembly operation in the area selected.

Another illustrative embodiment of the present disclosure provides an apparatus comprising a visualizer that displays a display for a portion of an aircraft on a display system in a mobile data processing system. The display on the display system comprises an image of the portion of the aircraft and hot spots over areas of the image. The hot spots correspond to installation plans for the areas over which the hot spots are located and the hot spots are selectable by user input. The visualizer also displays information on the display system in the mobile data processing system about the installation plan for an area in the areas when a hot spot in the hot spots corresponding to the area is selected by the user input. The display of the information on the display system provides a visual aid that enables performance of an assembly operation in the area selected.

Yet another illustrative embodiment provides an aircraft management system comprising a manufacturing system and a control system. The control system displays a display for a portion of an aircraft on a display system in a mobile data processing system. The display on the display system comprises an image of the portion of the aircraft and hot spots over areas of the image. The hot spots correspond to installation plans for the areas over which the hot spots are located and the hot spots are selectable by user input. The control system also displays information on the display system in the mobile data processing system about the installation plan for an area in the areas when a hot spot in the hot spots corresponding to the area is selected by the user input. The display of the information provides a visual aid that enables performance of an assembly operation in the area selected using the manufacturing system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an aircraft manufacturing environment in accordance with an illustrative embodiment;

FIG. 2 is an illustration of a block diagram of a graphical user interface displayed on a display system in accordance with an illustrative embodiment;

FIG. 3 is an illustration of data flow used to generate a display based on identification of the position of the mobile data processing system in accordance with an illustrative embodiment;

FIG. 4 is an illustration of a block diagram of data flow used to generate information in accordance with an illustrative embodiment;

FIG. 5 is an illustration of a graphical user interface for displaying a visual aid in accordance with an illustrative embodiment;

FIG. 6 is an illustration of a graphical user interface displaying a visual aid in accordance with an illustrative embodiment;

FIG. 7 is an illustration of a display of a portion of an aircraft in accordance with an illustrative embodiment;

FIG. 8 is an illustration of information displayed for an installation plan in accordance with an illustrative embodiment;

FIG. 9 is an illustration of information displayed for an installation plan in accordance with an illustrative embodiment;

FIG. 10 is an illustration of information displayed for an installation plan in accordance with an illustrative embodiment;

FIG. 11 is an illustration of information displayed for an installation plan in accordance with an illustrative embodiment;

FIG. 12 is an illustration of information displayed for an installation plan in accordance with an illustrative embodiment;

FIG. 13 is an illustration of a display of a portion of an aircraft in accordance with an illustrative embodiment;

FIG. 14 is an illustration of a display of a portion of an aircraft in accordance with an illustrative embodiment;

FIG. 15 is an illustration of a display of a portion of an aircraft in accordance with an illustrative embodiment;

FIG. 16 is an illustration of a flowchart of a process for a method for providing a visual aid in assembling an aircraft in accordance with an illustrative embodiment;

FIG. 17 is an illustration of a flowchart of a process for identifying a portion of an aircraft in accordance with an illustrative embodiment;

FIG. 18 is another illustration of a flowchart of a process for identifying a portion of an aircraft in accordance with an illustrative embodiment;

FIG. 19 is an illustration of a flowchart of a process for generating point-to-point measurements in accordance with an illustrative embodiment;

FIG. 20 is an illustration of a data processing system in the form of a block diagram in accordance with an illustrative embodiment;

FIG. 21 is an illustration of an aircraft manufacturing and service method in the form of a block diagram in accordance with an illustrative embodiment;

FIG. 22 is an illustration of an aircraft in the form of a block diagram in which an illustrative embodiment may be implemented; and

FIG. 23 is an illustration of a block diagram of a product management system in accordance with an illustrative embodiment.

### DETAILED DESCRIPTION

The illustrative embodiments recognize and take into account that currently used techniques for performing operations to assemble aircraft do not provide the visual aids needed to understand the location of the assembly, and how different parts in the assembly should be put together. The illustrative embodiments recognize and take into account that currently used materials such as engineering drawings do not show what the assembly should look like when the parts are assembled. The illustrative embodiments also recognize and take into account that the checklist does not provide visual aids with respect to the different entries that are to be verified during assembly of parts. Further, the two-dimensional photos provided may not provide a good understanding of the location of the area for the assembly.

The illustrative embodiments also recognize and take into account that the desired visual aids are currently not provided in a manner that is portable for use in forming operations in assembling an aircraft. For example, the illustrative embodiments recognize and take into account that a model or models of an entire aircraft may be useful and viewable by an operator at a data processing system such as a workstation. The workstation, however, is not portable and cannot be carried by the operator into the aircraft to perform an operation. As a result, the operator cannot view the model or models available at the workstation while working in the aircraft.

The illustrative embodiments recognize and take into account that some data processing systems are portable and can be carried by an operator. For example, the illustrative embodiments recognize and take into account that mobile data processing systems, such as a tablet, a mobile phone, a laptop computer, or other type of data processing system is available. The illustrative embodiments recognize and take into account, however, that the resources available on mobile data processing systems are not large enough to store and display a model or models of an entire aircraft. For example, the storage, random access memory, central processor unit, graphics processing units, and other components in a mobile data processing system may not be sufficient to display a model or models for an entire aircraft.

Further, the illustrative embodiments also recognize and take into account that generating the graphics data for display on a mobile data processing system is resource intensive when generating graphics data from the one or more models for aircraft. These models may be, for example, computer-aided design models.

Thus, the illustrative embodiments provide a method and apparatus that provide a technical solution to the issue of enabling the performance of operations as quickly and efficiently as desired when assembling an aircraft.

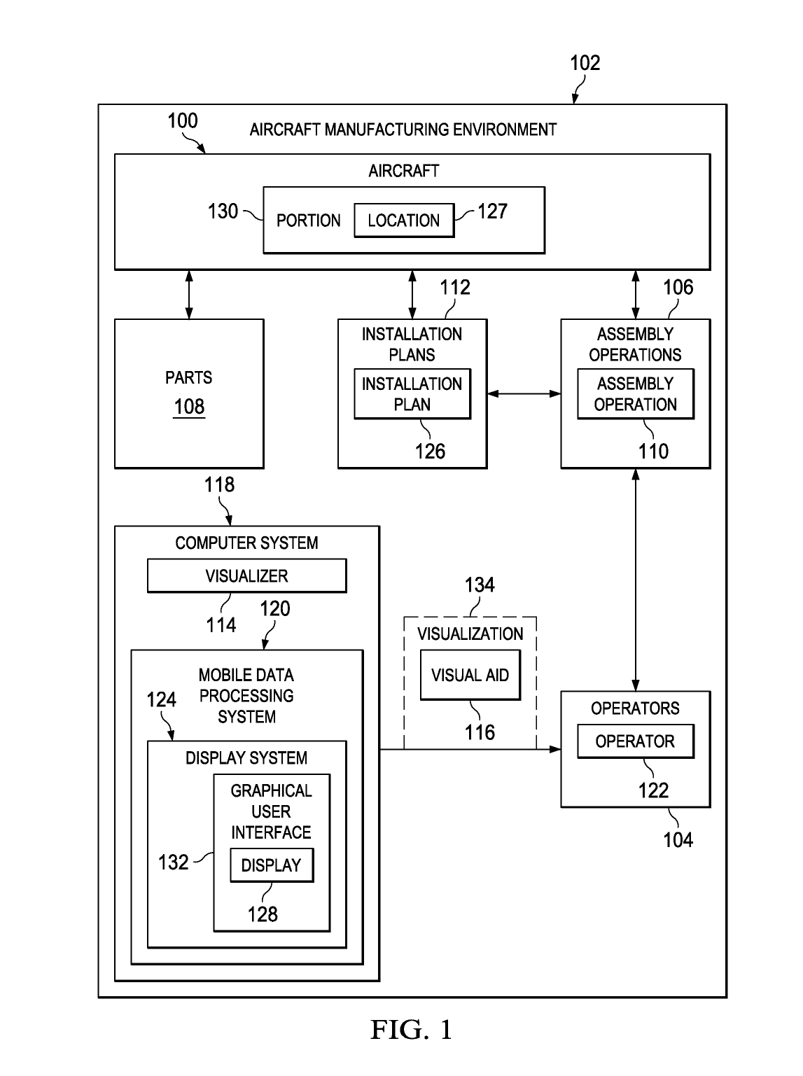

With reference now to the figures and in particular with reference to FIG. 1, an illustration of a block diagram of an aircraft manufacturing environment is depicted in accordance with an illustrative embodiment. As depicted, aircraft 100 is assembled in aircraft manufacturing environment 102. In the illustrative example, aircraft 100 may take various forms. For example, aircraft 100 may be a commercial airplane, a fighter aircraft, a rotorcraft, a helicopter, or some other suitable type of aircraft.

In these illustrative examples, operators 104 perform assembly operations 106 to assemble parts 108 to form aircraft 100. As depicted, assembly operations 106 may take various forms. For example, assembly operation 110 in assembly operations 106 may be selected from one of an assembly operation, an inspection operation, or some other suitable operation performed to manufacture aircraft 100.

Many of assembly operations 106 involve operators 104 entering aircraft 100 in a current state of aircraft 100 to perform assembly operations 106 with parts 108. In the illustrative example, assembly operations 106 are performed using installation plans 112. Installation plans 112 determine what assembly operations 106 are to be performed using parts 108. For example, installation plans 112 may define how parts 108 are to be assembled, inspected, tested, or some combination thereof to manufacture aircraft 100. For example, installation plans 112 may include instructions to assemble parts 108, engineering drawings, inspection instructions, images of assembled parts, and other suitable information.

In the illustrative example, visualizer 114 provides visual aid 116 to operator 122 in operators 104 to perform assembly operation 110 in assembly operations 106. As depicted, visualizer 114 may be implemented in software, hardware, firmware or a combination thereof. When software is used, the operations performed by visualizer 114 may be implemented in program code configured to run on hardware, such as a processor unit. When firmware is used, the operations performed by visualizer 114 may be implemented in program code and data and stored in persistent memory to run on a processor unit. When hardware is employed, the hardware may include circuits that operate to perform the operations in visualizer 114.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices.

Additionally, the processes may be implemented in organic components integrated with inorganic components and may be comprised entirely of organic components excluding a human being. For example, the processes may be implemented as circuits in organic semiconductors.

In this illustrative example, visualizer 114 is implemented in computer system 118. Computer system 118 includes one or more computers. These computers may be a computer such as a desktop personal computer, a workstation, a server computer, or some other type of computer.

Additionally, computer system 118 also may include mobile data processing system 120. Mobile data processing system 120 may be carried by operator 122 in operators 104. In these illustrative examples, mobile data processing system 120 may be hand-held, portable, or take some other form that may be carried by operator 122. Mobile data processing system 120 may be selected from one of a tablet computer, a mobile phone, a laptop computer, or some other data processing system that may be carried by operator 122.

In this illustrative example, visualizer 114 provides visual aid 116 using display system 124. As depicted, display system 124 is located in mobile data processing system 120. Display system 124 may be comprised of one or more display devices. A display device in display system 124 may be selected from one of a liquid crystal display (LCD), a light-emitting diode (LED) display, an organic light-emitting diode (OLED) display, or some other suitable type of display device.

In this illustrative example, mobile data processing system 120 is carried by operator 122 into aircraft 100 during assembly of aircraft 100. Mobile data processing system 120 is used by operator 122 to obtain visual aid 116 to perform assembly operation 110 in these illustrative examples. As depicted, assembly operation 110 may be performed following installation plan 126 in installation plans 112. In other words, operator 122 uses mobile data processing system 120 in location 127 relative to aircraft 100 to perform assembly operation 110.

As depicted, visualizer 114 provides visual aid 116 in assembling aircraft 100. In this illustrative example, visualizer 114 displays display 128 for portion 130 of aircraft 100 on display system 124 in mobile data processing system 120. In the illustrative example, portion 130 of aircraft 100 is selected from one of an interior of aircraft 100 or an exterior of aircraft 100. Portion 130 may include some or all of aircraft 100.

As depicted, display 128 is displayed within graphical user interface 132 on display system 124 in mobile data processing system 120. In the illustrative example, display 128 for portion 130 provides visualization 134 in the form of visual aid 116 in a manner that uses fewer resources as compared to current techniques that display a model or models for an entire aircraft.

In this manner, operator 122 may carry mobile data processing system 120 and view display 128 for portion 130 of aircraft 100 when moving to location 127 in aircraft 100. In this example, portion 130 includes location 127 in which operator 122 performs assembly operation 110. With visualization 134, operator 122 may perform assembly operation 110 more quickly than with currently used systems for guiding operator 122.

Additionally, display 128 is generated on display system 124 in mobile data processing system 120 in a manner that reduces the resources needed to provide portability in providing display 128. The amount of resources is reduced as compared to currently used techniques that display a model or models of an entire aircraft that are viewable by an operator at a data processing system such as a workstation.

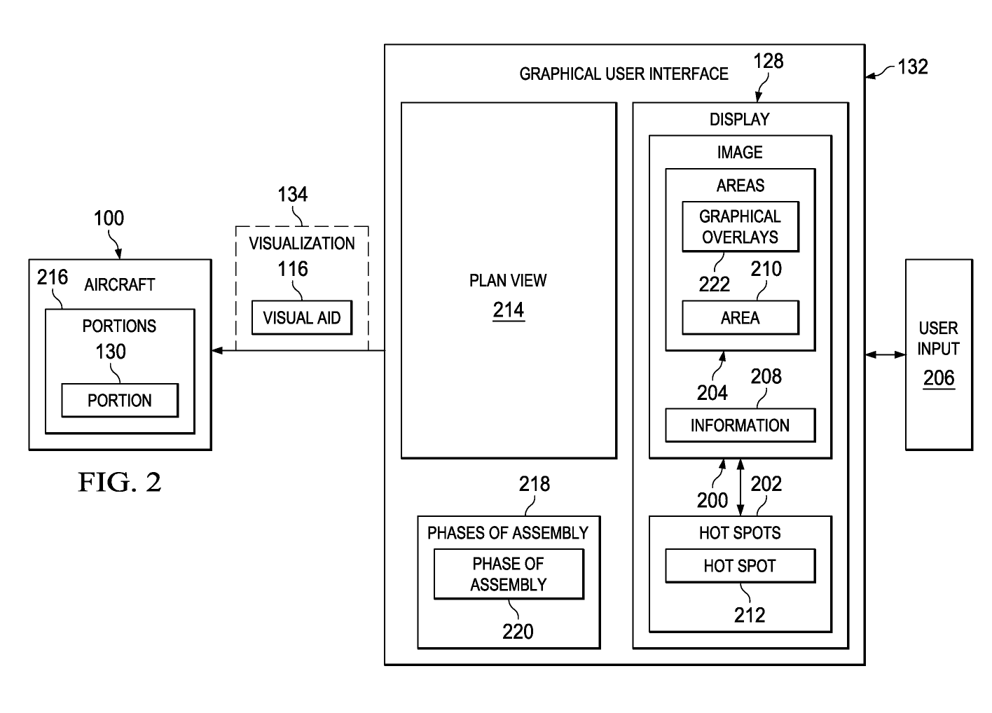

With reference now to FIG. 2, an illustration of a block diagram of a graphical user interface displayed on a display system is depicted in accordance with an illustrative embodiment. As depicted, one manner in which display 128 may be generated by visualizer 114 in FIG. 1 is shown in this figure. In the illustrative examples, the same reference numeral may be used in more than one figure. This reuse of the reference numeral in different figures represents the same element being present in the different figures.

As depicted, display 128 is displayed in graphical user interface 132 and comprises image 200 of portion 130 of aircraft 100 and hot spots 202 over areas 204 of image 200. In this illustrative example, hot spots 202 correspond to installation plans 112 in FIG. 1 for areas 204 over which hot spots 202 are located on image 200. Visualizer 114 in FIG. 1 displays hot spots 202 using graphical overlays 222 in association with areas 204 of image 200 where assembly operations 106 are planned based on installation plans 112 in FIG. 1. As depicted, graphical overlays 222 are graphical indications of hot spots 202. In other words, graphical overlays 222 allow an operator to see where hot spots 202 are located. In the illustrative example, hot spots 202 are selectable by user input 206.

A graphical overlay is considered to be associated with an area when the graphical overlay is displayed in the area, on the area, near the area, or in some other manner that draws the attention of a person viewing the graphical overlay to the area of which the graphical overlay is associated. Graphical overlays 222 may take various forms. For example, graphical overlays 222 may take the form of icons, texts, colors, animations, lines, images, or other suitable types of graphical overlays.

Additionally, display 128 also includes information 208 about installation plan 126 in FIG. 1 for area 210 in areas 204 when hot spot 212 in hot spots 202 corresponding to area 210 is selected by user input 206. User input 206 may take various forms. For example, user input 206 may be at least one of a rollover, a pointer hovering over hot spot 212, a mouse click when a pointer is over hot spot 212, or some other suitable type of user input. As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The display of information 208 in display 128 provides visual aid 116 that enables performance of assembly operation 110 in area 210 that is selected in FIG. 1. Further, in this illustrative example, visualizer 114 in FIG. 1 may display plan view 214 in graphical user interface 132. In this illustrative example, plan view 214 is an orthographic projection of a three-dimensional object, such as aircraft 100, from the position of a horizontal plane through aircraft 100. In other words, plan view 214 is a section viewed from the top of aircraft 100.

As depicted, visualizer 114 displays plan view 214 of aircraft 100 in which plan view 214 represents portions 216 of aircraft 100 that are selectable to present display 128 for portion 130 of aircraft 100 selected from portions 216 in plan view 214. In response to the selection of portion 130 from plan view 214, visualizer 114 displays display 128 corresponding to portion 130 selected from portions 216 of aircraft 100.

Further, visualizer 114 also may display phases of assembly 218 for aircraft 100 that are selectable. The selection of phase of assembly 220 from phases of assembly 218 causes image 200 for portion 130 as selected to correspond to phase of assembly 220. For example, the selection of a portion of a passenger cabin in a phase of assembly that is prior to the installation of seats results in image 200 that is used in display 128 to show the passenger cabin without seats.

In this manner, graphical user interface 132 with at least one of display 128, plan view 214, and phases of assembly 218 may provide visualization 134 of aircraft 100. As depicted, visualization 134 takes the form of visual aid 116 that may be used by operator 122 while operator 122 is in a location inside or outside of aircraft 100.

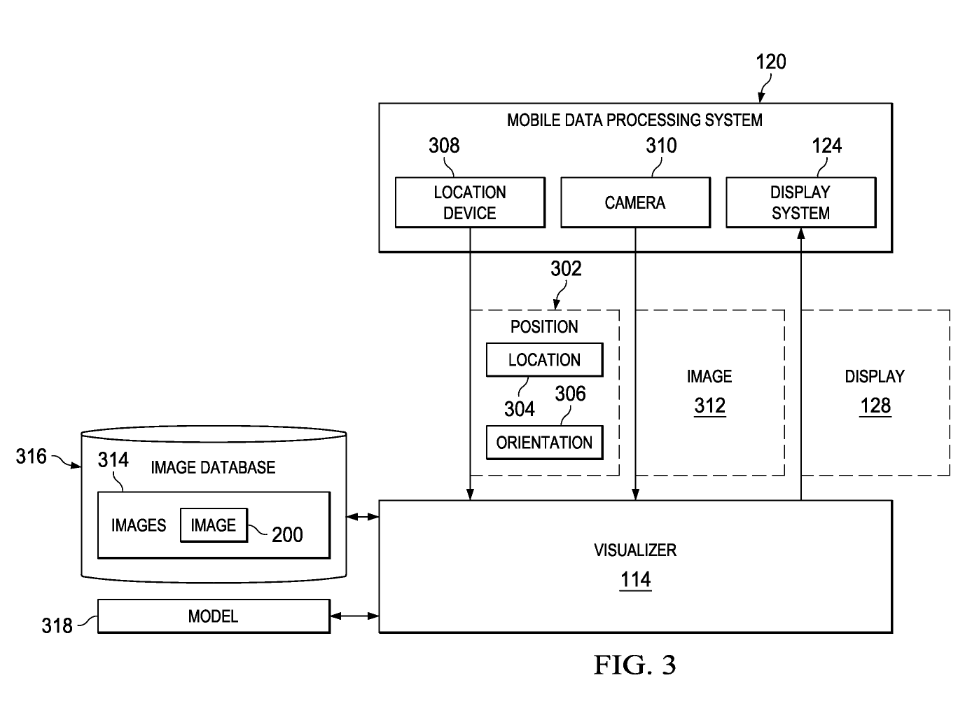

Turning next to FIG. 3, an illustration of data flow used to generate a display based on identification of the position of the mobile data processing system is depicted in accordance with an illustrative embodiment. In the illustrative example, visualizer 114 may identify position 302 of mobile data processing system 120. In the illustrative example, position 302 of mobile data processing system 120 may be used to identify which of images 314 are used for generating display 128. In particular, position 302 may be used to identify image 200 from images 314.

In this illustrative example, position 302 describes location 304 of mobile data processing system 120. In the illustrative example, position 302 is identified relative to aircraft 100 in FIG. 1. For example, position 302 may be outside of aircraft 100 or inside of aircraft 100.

As depicted, location 304 may be described using coordinates such as those used in a Cartesian coordinate system. Additionally, position 302 also may include orientation 306 of mobile data processing system 120.

In these illustrative examples, location 304 may be identified using a number of different types of mechanisms. For example, location 304 may be identified using location device 308 in mobile data processing system 120. Location device 308 may be, for example, a global positioning system receiver in mobile data processing system 120. The global positioning system receiver may send position 302 to visualizer 114.

In another illustrative example, mobile data processing system 120 may include camera 310. Camera 310 may generate image 312 of aircraft 100 while operator 122 in FIG. 1 carries mobile data processing system 120 inside or outside of aircraft 100.

Camera 310 sends image 312 to visualizer 114. In this illustrative example, camera 310 may be a stereo camera or other suitable type of camera. Visualizer 114 may use image 312 to identify position 302 of mobile data processing system 120 relative to aircraft 100. For example, image 312 may be compared to images 314 of aircraft 100 in image database 316. Images 314 are images that may be used to generate display 128 in the illustrative example.

As depicted, image 312 may be compared to images 314 to identify an image with the images 314 for use in generating display 120. The comparison may be made using currently available image comparison techniques. The comparison is performed to find an image in images 314 that is closest to image 312. Currently used image comparison techniques include, for example, without limitation, image subtraction, color overlay and image flashing or alternating, or other suitable techniques.

For example, image subtraction algebraically combines the magnitude of each point or pixel of the reference image and test image so that like parts cancel and only differences remain. In the color overlay approach, each image is filtered with a different color so that differences appear in one or the other color and like parts appear as a blend of both colors. In image flashing, first one and then the other image is flashed on a screen: like parts remain steady, while differences blink.

In one illustrative example, images 314 may be generated in a manner that allows for distances between points in images 314 to be identified. For example, images 314 may be sets of images. Each set of images in images 314 may be taken from offset positions such as with a stereo camera. Knowing the offset distance between the cameras generating the images allows for measuring distances. This offset distance may be included as part of the set of images. The operator may then obtain point-to-point measurements for aircraft 100 when images 314 are taken from aircraft 100.

As depicted, pixels in the images may be scaled with respect to known distances from computer aided (CAD) models. Distances between different features for objects in a location in an image may be identified from the computer aided model of the location. These distances may be used to scale pixels to provide an ability to identify distances from selecting points in the image. In other words, the pixels in the image may be correlated to distances. The distance between pixels for different points for object may be identified using a computer aided design model of the object. In this manner, the selection of pixels at different points in an image may be used to identify distances between those points selected.

Alternatively, a point cloud may be generated for the objects in the location. The point cloud may then be correlated to images for the location.

In one illustrative example, the display of image 200 also may include displaying another image taken at the same time from the position offset from image 200. With this type of implementation, display system 124 may be this type of device that allows for viewing a set of images on an auto-stereoscopic display device. This type of device allows for viewing a set of images to provide an ability to measure distances between points selected in a set of images.

In this manner, the distance measurements may be generated from display 128. Currently available techniques to be used to generate images 314 in which measurements may be made by selecting points within images 314. For example, identifying distances from computer aided design models and correlating those distances within those computer-aided design models to images 314, generating point clouds, or other techniques may be used.

Visualizer 114 may correlate image 312 generated by camera 310 in mobile data processing system 120 to one of images 314 to identify position 302 of mobile data processing system 120. In another illustrative example, visualizer 114 may perform object recognition to identify parts 108 that are in image 312. Currently used object detection techniques may be used. These techniques may include approaches based on computer-aided design like object model methods, appearance based methods, feature based methods, and other suitable techniques.

Computer-aided design like object model based methods may compare images to features in computer-aided design models. Appearance based methods may involve using example images in the form of templates or exemplars of the objects to be recognized. Feature based methods may include searching defined matches between object features and features in an image. Other techniques also include using genetic algorithms, neural networks and other to detect objects

The identification of parts 108 may then be compared to model 318 for aircraft 100. Model 318 may be, for example, a computer aided design (CAD) model. Based on this comparison, visualizer 114 may identify position 302 of mobile data processing system 120.

With position 302, visualizer 114 identifies image 200 from images 314 in image database 316 for generating display 128. As depicted, images 314 are formed from combining photographic images with overlapping fields of view for aircraft 100. For example, image 200 is formed from combining photographic images with overlapping fields of view for portion 130 of aircraft 100. The creation of image 200 may be performed using various image combining processes such as image stitching or photo stitching.

With the identification of image 200, visualizer 114 generates display 128 of portion 130 of aircraft 100 as identified using image 200 of portion 130 of aircraft 100 and hot spots 202 over areas 204 of image 200 in FIG. 2 based on position 302 of mobile data processing system 120. Visualizer 114 then sends display 128 to mobile data processing system 120 for display on display system 124. In an illustrative example, mobile data processing system 120 may be a tablet computer, a mobile phone, or some other suitable type of mobile data processing system. Display system 124 may take the form of a touchscreen allowing for gestures to be used to interact with display 128.

In this manner, visualizer 114 identifies display 128 of portion 130 that is relevant to where operator 122 is located based on position 302 of mobile data processing system 120. Display 128 may change as operator 122 moves to different places in or on aircraft 100. Identification of images based on position 302 may be made using image comparison techniques as described above. Additionally, other position identification techniques also may be used. For example, an indoor positioning system based on sensor data may be used. For example, magnetic positioning, dead reckoning, optical signals, radio signals, acoustic signals, and other types of information may be used to identify the location of mobile data processing system 302. The systems typically use translation in which three measurements are made.

For example, a wireless positioning system may be used in which wireless access points transmit signals that have selected intensities. Each wireless access point may have a different intensity at which wireless signals are transmitted. As a result, mobile data processing system 120 may identify a distance to a particular wireless access point based on signal strength. When the distances are identified to two or more wireless access points, those distances may then be used to identify position 302 of mobile data processing system 120.

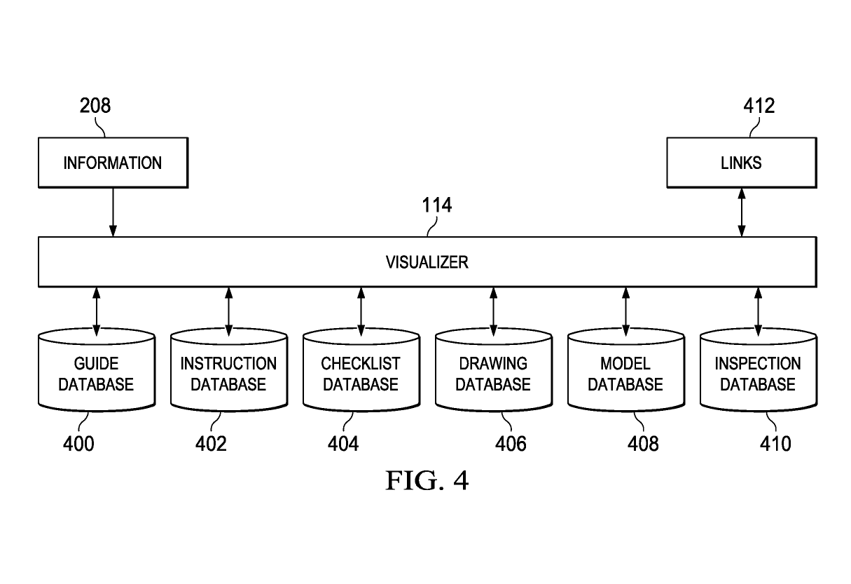

Turning next to FIG. 4, an illustration of a block diagram of data flow used to generate information is depicted in accordance with an illustrative embodiment. Visualizer 114 also identifies information 208 for display system 124 in FIG. 1. Information 208 may be identified based on position 302 of mobile data processing system 120 with respect to aircraft 100. This position may be identified using various techniques described above. These techniques include, for example, comparing an image generated by a mobile data processing system with images of the aircraft, a wireless positioning system, a dead reckoning system, or other suitable types of systems that may be used to identify position 302 of mobile data processing system 120.

As depicted, information 208 is information for installation plan 126 in FIG. 1. Information 208 is identified for display 128 based on installation plan 126 that is associated with hot spot 212 selected by user input 206 shown in FIG. 2. Information 208 may take a number of different forms.

For example, information 208 may include at least one of a guide to locate parts 108 installed during assembly of aircraft 100 in FIG. 1; instructions for assembling a group of parts 108, a checklist of parts 108, a group of links that are selectable to display at least one of an engineering drawing, a computer aided design model, or inspection data, or other suitable types of information.

In this illustrative example, visualizer 114 may obtain information 208 from a number of different sources. For example, visualizer 114 may access at least one of guide database 400, instruction database 402, checklist database 404, drawing database 406, model database 408, inspection database 410, or some other suitable source of information.

As depicted, guide database 400 may include drawings, descriptions, photos, videos, and other information that may be used to guide an operator to the location of the group of parts for an installation plan. Instruction database 402 may include written instructions, photos, videos, and other information to tell an operator how to assemble a group of parts, inspect a group of parts, or perform some other operations according to the installation plan for which the information is identified.

As depicted, checklist database 404 includes checklists from which the checklist for the installation plan is identified for use in displaying information 208. The checklist may identify operations, parts, or other information that should be checked during an assembly operation.

Drawing database 406 is a database of engineering drawings. In these illustrative examples, these drawings may be two-dimensional drawings for parts in which operations are to be performed from the installation plan.

In the illustrative example, model database 408 is a database of models for a group of parts. These models may be for a part or an assembly of parts. An installation plan is associated with a group of models in model database 408. In this manner, the models that may be displayed may be smaller in size rather than providing access to a model of an entire aircraft or a large portion of the aircraft including parts that are not part of the installation plan. For example, a model for an installation plan may be a model of a luggage bin, a window, a seat, or some other group of parts in the installation plan.

Access to information in these databases may occur through links 412 that are generated by visualizer 114 and included in information 208. As depicted, links 412 are pointers to the information in one of the databases. Links 412 may be, for example, universal resource locators (URLs).

As a result, the amount of information that is stored or processed by mobile data processing system 120 in FIG. 1 may be reduced as compared to currently used techniques. As a result, an ability to obtain information for a particular installation plan is provided to an operator in a manner such that the operator is able to access this information when moving inside or outside of the aircraft to perform one or more operations for the installation plan.

The illustration of aircraft manufacturing environment 102 and the different components in FIGS. 1-4 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, computer system 118 is shown as having a single data processing system. One or more mobile data processing systems in addition to mobile data processing system 120 may be present in computer system 118.

As another example, visualizer 114 may be located in at least one of mobile data processing system 120, another computer in computer system 118, or distributed through different computers in computer system 118. When visualizer 114 is located in another computer other than mobile data processing system 120, visualizer 114 generates display 128 and sends display 128 to mobile data processing system 120 to present to operator 122 on display system 124. In another illustrative example, visualizer 114 may be distributed across multiple computers including mobile data processing system 120.

In still another example, information 208 may include other types of information from other databases in addition or in place of guide database 400, instruction database 402, checklist database 404, drawing database 406, model database 408, or inspection database 410. For example, a video database showing performance of an assembly operation may be used by visualizer 114 to identify information 208 for display 128 in graphical user interface 132.

As another example, display 128 may be displayed on other data processing systems other than mobile data processing system 120. For example, display 128 may be displayed on a display system for a desktop computer, a workstation, or some other suitable type of data processing system.

In yet another illustrative example, in place for using sets of images generated using a stereo camera, a point cloud may be generated for the images. In other words, each image used for a display has a point cloud associated with the image. The point cloud is used to identify locations of points in the image and may be used to generate point-to-point measurements for points selected in the image.

The point cloud is a set of data points in the coordinate system in which the data points are generated using a three-dimensional scanner. The three-dimensional scanner may be, for example, a laser that generates measurements that identify different points on the surface of an object. This point cloud may be correlated to the image and used to identify distances between points when user input selecting two points in the image is received.

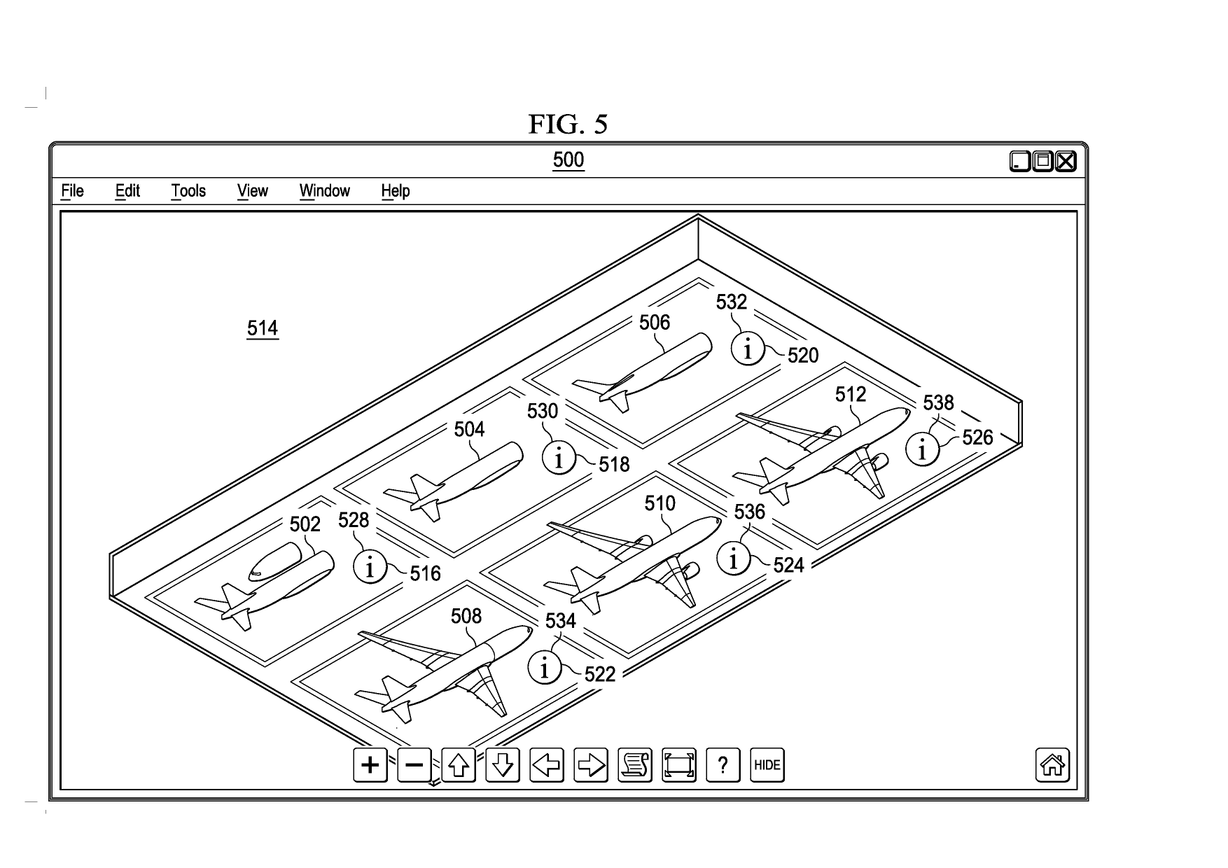

With reference next to FIGS. 5-11, an illustration of a graphical user interface displaying visual aids for use by an operator to perform an assembly operation for installation plan is depicted in accordance with an illustrative embodiment. With reference first to FIG. 5, an illustration of a graphical user interface for displaying a visual aid is depicted in accordance with an illustrative embodiment. As depicted, graphical user interface 500 is an example of one implementation for graphical user interface 132 in FIG. 1.

As depicted, phases of assembly are displayed in graphical user interface 500. These phases of assembly are represented by station 502, station 504, station 506, station 508, station 510, and station 512 as shown in image 514 in graphical user interface 500. In the illustrative example, each station is depicted by an aircraft in a particular phase of assembly at a station in image 514.

Each of these stations is selectable through a hot spot. As depicted, hot spot 516, hot spot 518, hot spot 520, hot spot 522, hot spot 524, and hot spot 526 are shown using graphical overlay 528, graphical overlay 530, graphical overlay 532, graphical overlay 534, graphical overlay 536, and graphical overlay 538 that are displayed in association with station 502, station 504, station 506, station 508, station 510, and station 512, respectively.

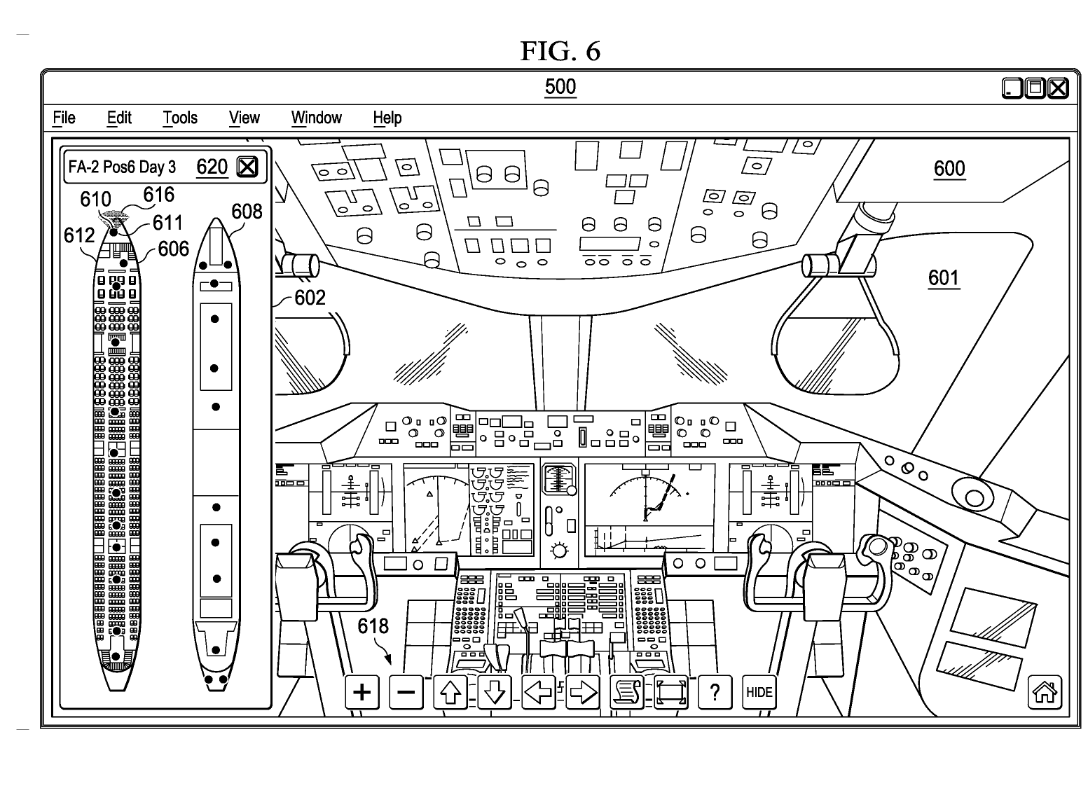

With reference now to FIG. 6, an illustration of a graphical user interface displaying a visual aid is depicted in accordance with an illustrative embodiment. In this figure, station 512 shown in image 514 has been selected through user input selecting hot spot 526 in FIG. 5.

In this example, display 600 in graphical user interface 500 includes image 601 of the cockpit in the aircraft. Display 600 is shown in this illustrative example as a default starting point after a phase of assembly has been selected through the selection of a station in FIG. 5.

Additionally, plan view 602 is displayed in graphical user interface 500. As depicted, plan view 602 is a plan view of an aircraft. Plan view 602 illustrates portions of the aircraft that may be selected for obtaining visual aids in forming an assembly operation. As seen in this view, portions are shown on level 606 and level 608 of the aircraft. In this illustrative example, level 606 is a passenger area while level 608 is a cargo area for the aircraft. Plan view 602 displayed in graphical user interface 500 may receive user input to select a particular portion of the aircraft. The selection of the portion is made using hot spots as seen through the graphical overlays.

In the illustrative example, each of these hot spots shows a portion of the aircraft that may be viewed with a display. A portion corresponding to a hot spot may be selected to present in display 600 in a manner that includes an image of the portion selected.

For example, graphical overlay 610 represents hot spot 611 for portion 612 of the aircraft as shown in plan view 602. In this illustrative example, image 601 is the cockpit of the aircraft in display 600. Further, graphical indicator 616 in plan view 602 indicates which part of portion 612 is being viewed in image 601. As depicted, graphical indicator 616 is a color. As depicted, image 601 may be navigated 360 degrees around and 180 degrees vertically in the illustrative example. When the view changes, graphical indicator 616 displayed in plan view 602 also changes to correspond to the current view as seen in image 601.

The navigation in this illustrative example may occur using controls 618 which are used to navigate image 601 displayed. Other mechanisms other than user input to control controls 618 using a mouse or gestures on a touch screen may be used. For example, a keyboard, a trackball, a joystick, touchscreen, or some other device may be used to navigate image 601. Also, phase of assembly identifier 620 identifies the phase of assembly that is displayed.

In another illustrative example, camera 310 in mobile data processing 120 generates image 312. Image 312 is compared with images 314 in image database 316 in which images 314 includes images of aircraft 100 in different phases of assembly. The comparison is made to identify the phase of assembly for aircraft 100. If a comparison does not yield a match, the operator may be prompted to select a phase of assembly using plan view 602.

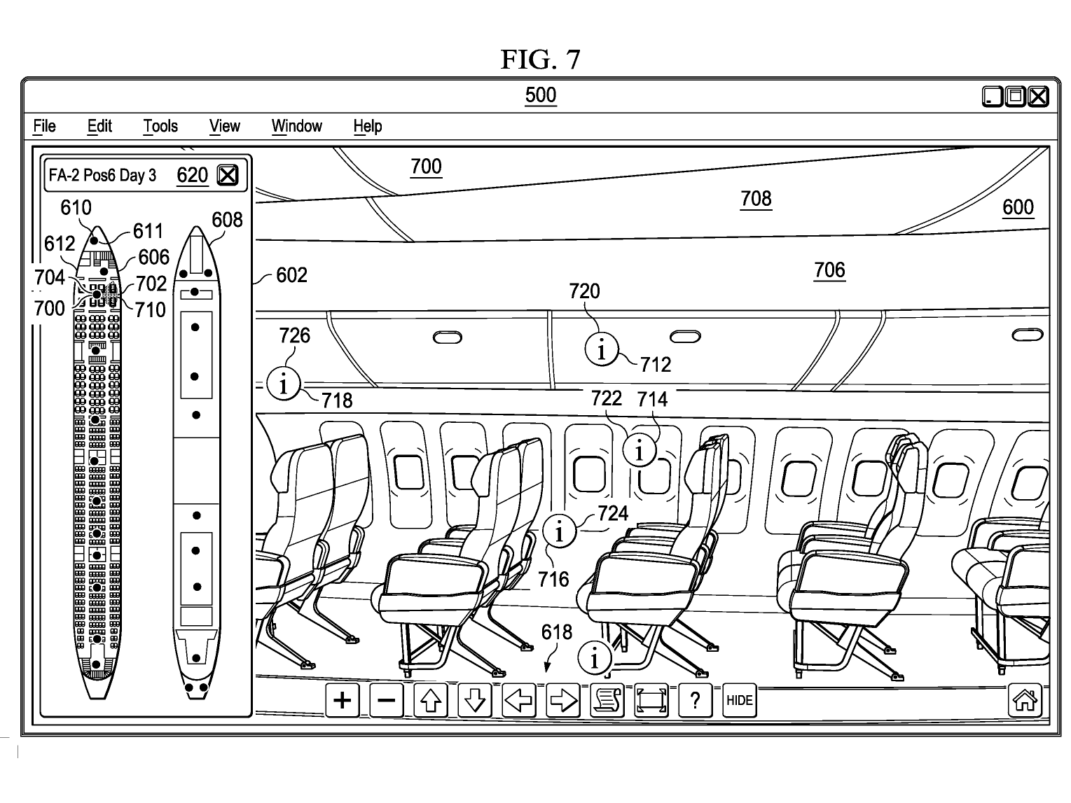

In FIG. 7, an illustration of a display of a portion of an aircraft is depicted in accordance with an illustrative embodiment. In this figure, hot spot 700 in plan view 602 has been selected for viewing portion 702 of the aircraft. In this illustrative example, hot spot 700 is shown in plan view 602 in graphical user interface 500 using graphical overlay 704.

The selection of hot spot 700 results in graphical user interface 500 showing display 706. Display 706 includes which of image 708 is for portion 702 of the aircraft as shown in plan view 602.

Also, graphical indicator 710 is displayed on plan view 602 and indicates the view of portion 702 displayed in image 708. As depicted, graphical indicator 710 is a color. In this example, graphical indicator 710 indicates that the port side of portion 702 is shown in image 708.

In the illustrative example, hot spot 712, hot spot 714, hot spot 716, and hot spot 718 are displayed using graphic overlay 720, graphic overlay 722, graphic overlay 724, and graphic overlay 726 on image 708. These hot spots correspond to installation plans. The selection of one of the hot spots causes a display of information for an installation plan that corresponds to the selected hot spot.

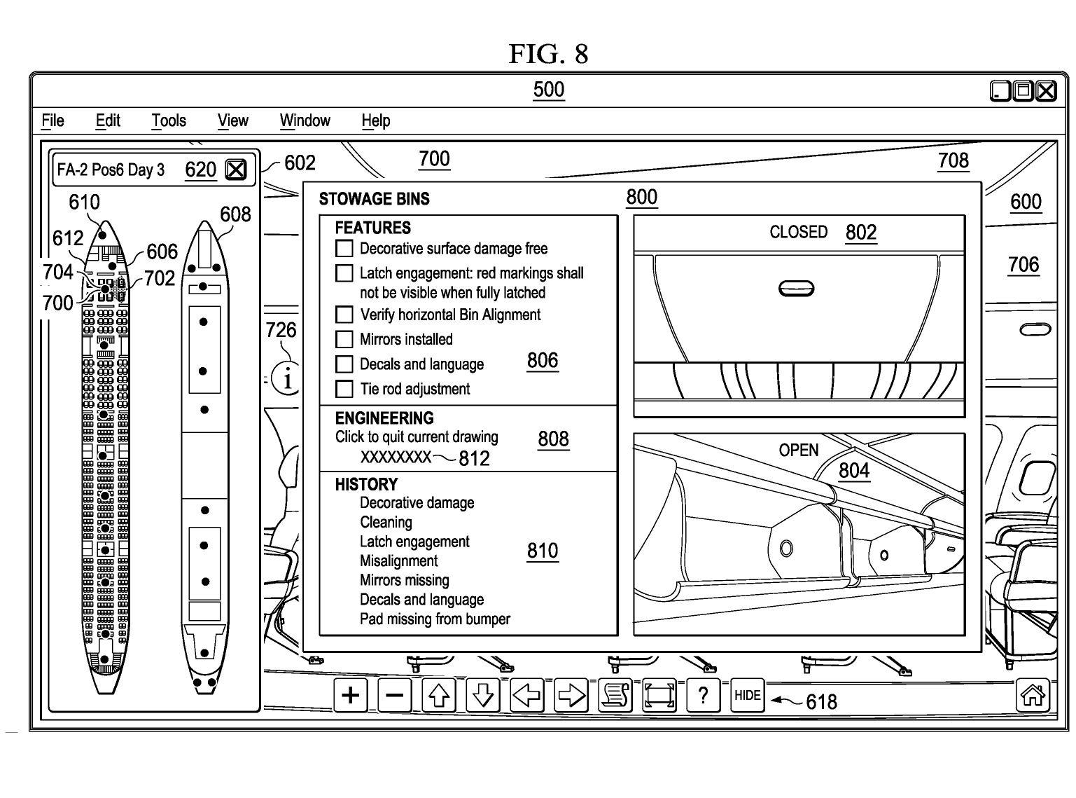

Turning now to FIG. 8, an illustration of information displayed for an installation plan is depicted in accordance with an illustrative embodiment. In this view, hot spot 712 (not shown in this view) has been selected and information about the installation plan is displayed in popup window 800. Image 802 and image 804 are pictures of a stowage bin for the installation plan. In this illustrative example, image 802 shows a stowage bin in a closed position, while image 804 shows a stowage bin in an open position.

Additionally, the information in popup window 800 also includes a checklist in section 806, engineering information in section 808, and a history of issues in section 810. The checklist shows features that should be checked for the stowage bin in the installation plan.

As depicted, section 808 includes link 812 to access engineering drawings for the bin. The history of issues in section 810 lists issues that have occurred in previous installations of the bin.

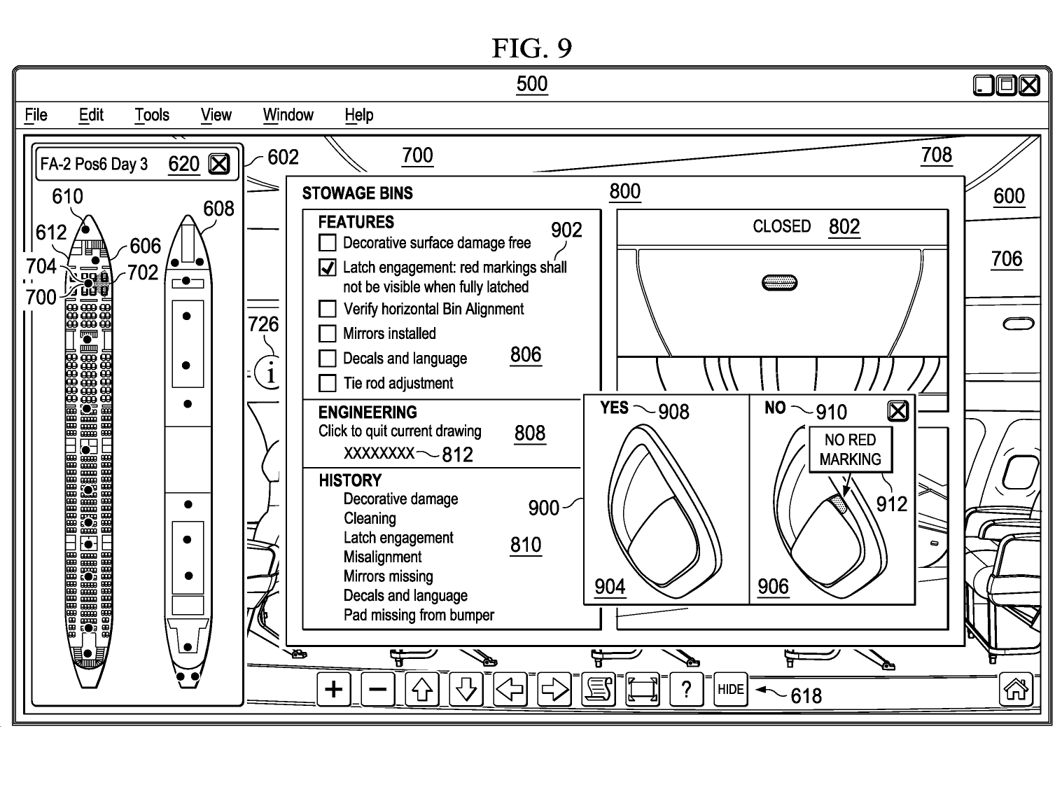

With reference now to FIG. 9, an illustration of information displayed for an installation plan is depicted in accordance with an illustrative embodiment. In this figure, graphical user interface 500 displays popup window 900. Popup window 900 is displayed when item 902 is selected from the checklist in section 806. In this illustrative example, item 902 indicates when markings should not be visible on a latch for the stowage as an item that should be checked.

As depicted, popup window 900 shows image 904 and image 906 of a portion of a stowage bin. In this illustrative example, callout 908 on image 904 provides a visual aid to a correct installation for a latch. Callout 910 on image 906 indicates that the image is one of an incorrect installation of a latch. Additionally, callout 912 indicates the red marking on the latch should not be seen when the stowage bin is in a closed position.

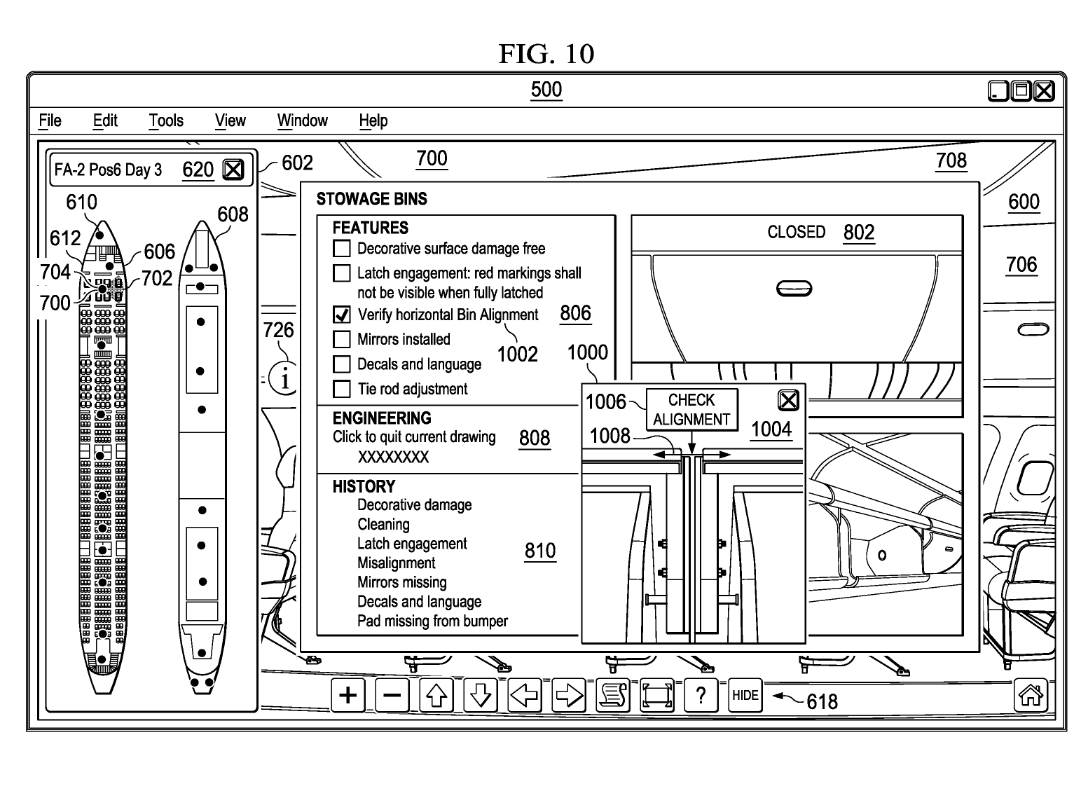

With reference now to FIG. 10, an illustration of information displayed for an installation plan is depicted in accordance with an illustrative embodiment. In this figure, graphical user interface 500 displays popup window 1000.

Popup window 1000 is displayed when item 1002 is selected from the checklist in section 806. In this illustrative example, item 1002 indicates that the alignment of the stowage bin should be checked.

As depicted, popup window 1000 shows image 1004 of a portion of a stowage bin. In this illustrative example, callout 1006 on image 1004 provides a visual aid as to what should be measured for item 1002 in the checklist. Also, arrow 1008 shows the direction in which the alignment should be checked for item 1002 on the checklist.

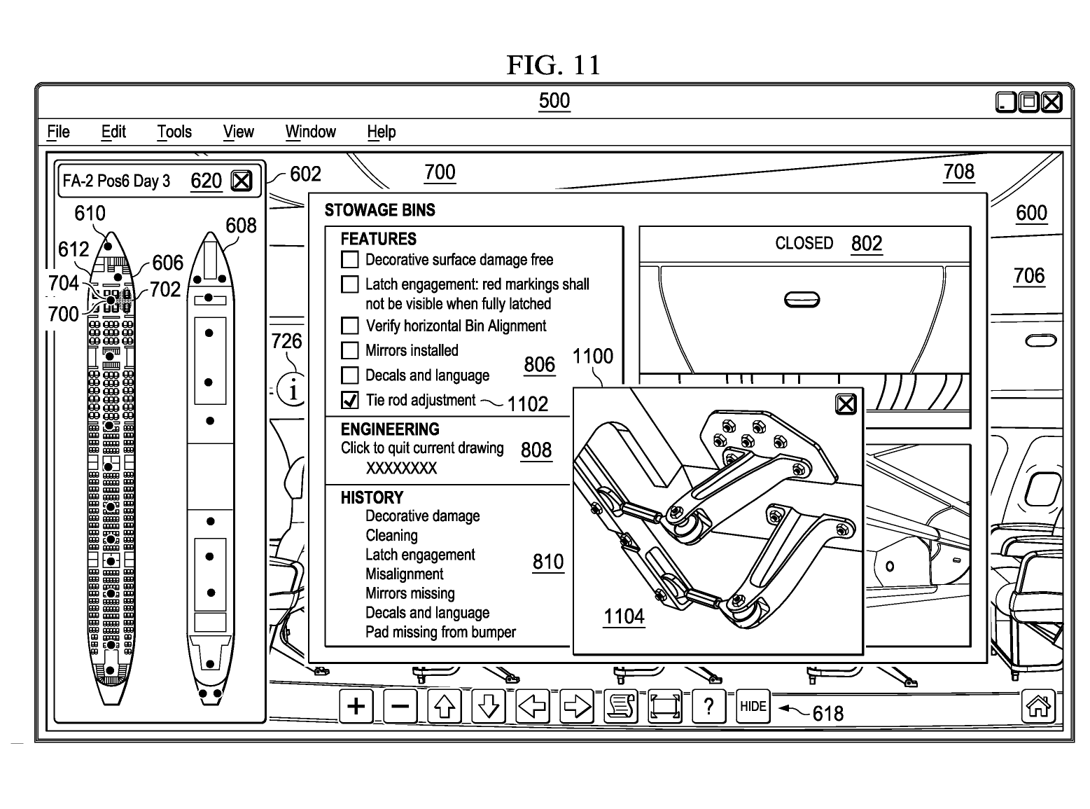

Turning next to FIG. 11, an illustration of information displayed for an installation plan is depicted in accordance with an illustrative embodiment. In this illustrative example, graphical user interface 500 displays popup window 1100. Popup window 1100 is displayed when item 1102 is selected from the checklist in section 806. Popup window 1100 shows image 1104 of tie rods for the stowage bin.

Some items in the checklist are presented only for some phases of assembly and may not be visible or accessible in other phases of assembly. Detailed popup windows, such as popup window 1000 and popup window 1100, are provided as guides to perform at least one of inspection, installation, or other types of operations. In this manner, visual aids may be provided for each phase of assembly for an aircraft.

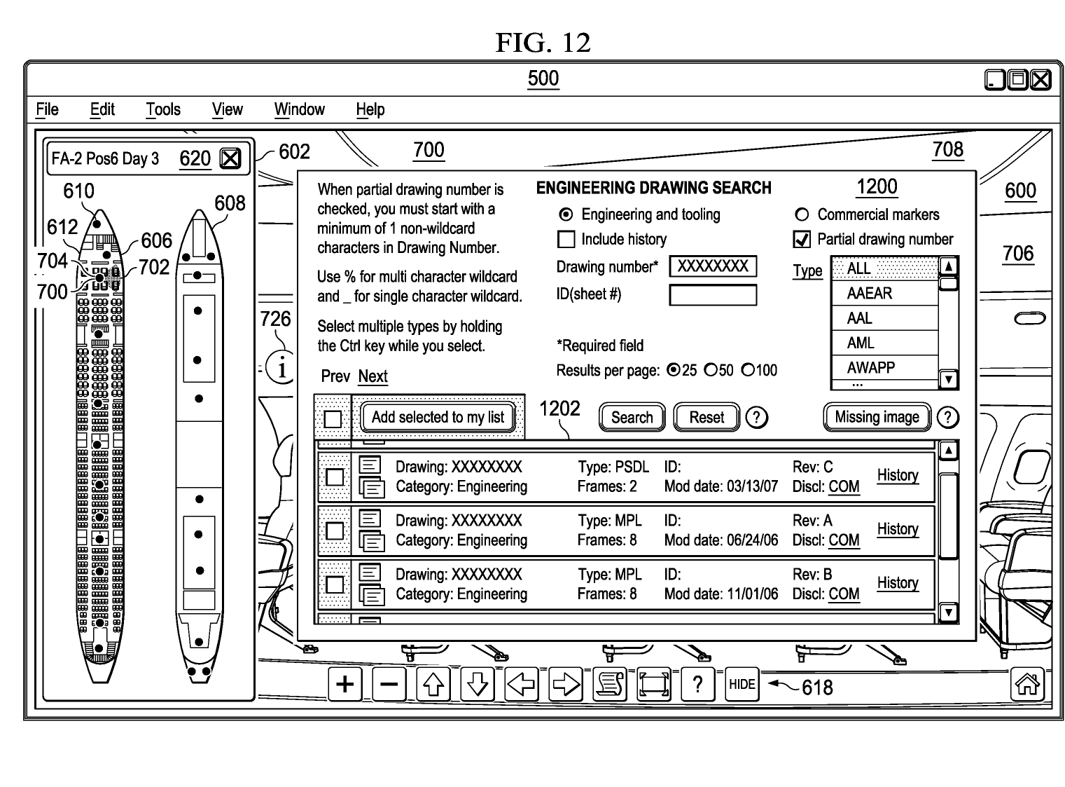

With reference next to FIG. 12, an illustration of information displayed for an installation plan is depicted in accordance with an illustrative embodiment. In this illustrative example, graphical user interface 500 displays popup window 1200 when link 812 in section 810 in FIG. 8 is selected.

In this illustrative example, popup window 1200 shows list 1202 of engineering drawings that may be displayed for providing additional information in performing assembly operations. List 1202 includes engineering drawings for stowage bins that may be applicable for installing stowage bins. These drawings may be two-dimensional or three-dimensional drawings. Three-dimensional drawings may be viewed using a model of the stowage bin. In the illustrative example, the model is for the part or assembly of parts, such as a stowage bin. Other parts of the aircraft are not included in the model in this illustrative example. In other illustrative examples, parts of the aircraft relevant to the stowage bin may be included to provide information needed for performing assembly operations for the stowage bin.

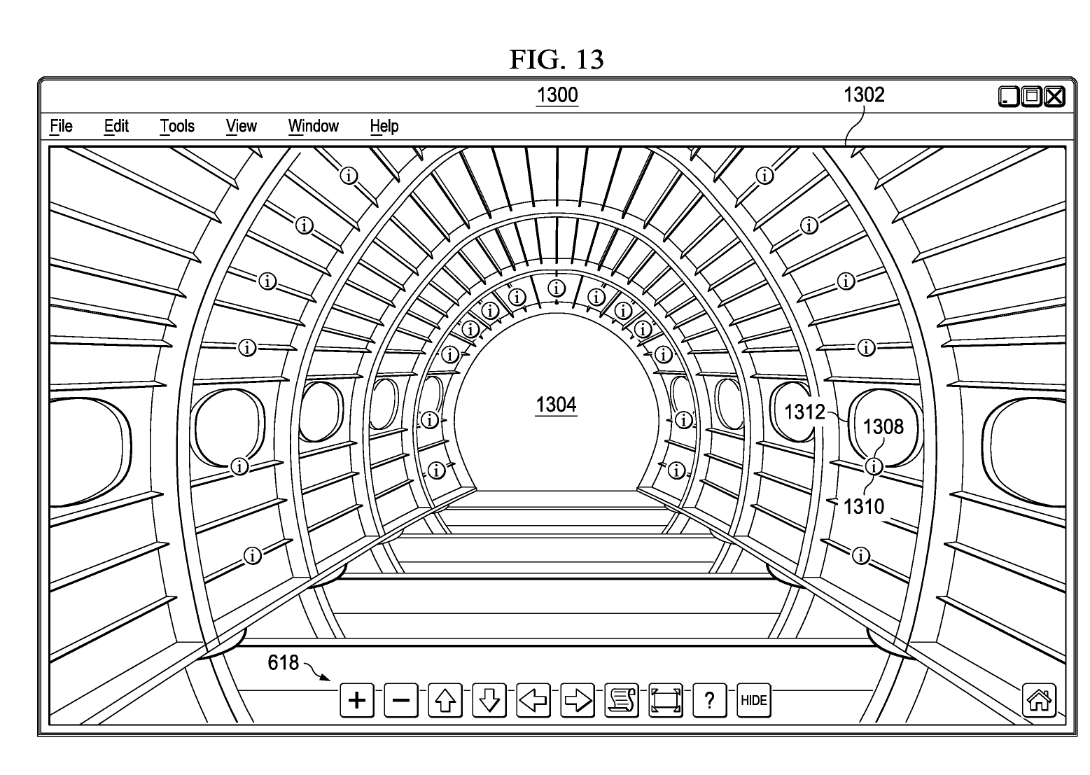

FIGS. 13-15 are examples of other examples of a display of an image and information in a graphical user interface providing visual aids to an operator to perform an assembly operation. With reference next to FIG. 13, an illustration of a display of a portion of an aircraft is depicted in accordance with an illustrative embodiment. In this example, graphical user interface 1300 is an example of another implementation for graphical user interface 132 shown in block form in FIG. 1.

As depicted, graphical user interface 1300 includes display 1302 in which image 1304 is shown in display 1302. Image 1304 is an image of an interior of an aircraft. Image 1304 is at a stage of assembly where the fuselage is seen in image 1304. As depicted, hot spots are displayed as graphical overlays for installation plans regarding the fuselage. In this illustrative example, graphical overlay 1308 is displayed for hot spot 1310 for an installation plan for window 1312 shown in the fuselage in image 1304.

The location of graphical overlay 1308 serves as a visual guide to find the location in the aircraft to perform an assembly operation as set out by the installation plan. In other words, graphical overlay 1308 may serve as a guide to an operator to find window 1312 in the aircraft as shown in image 1304. The operator may carry a mobile data processing system and view graphical user interface 1300 with image 1304 with graphical overlay 1308 associated with window 1312 while looking for the location of window 1312 in the aircraft. Graphical overlay 1308 is considered to be associated with window 1312 in image 1304 when the location, the look of graphical overlay 1308, draws the attention of an operator to window 1312.

Further, image 1304 shows other parts in the aircraft that may be used by the operator as a reference to find window 1312 while the operator is inside the aircraft. These assembly operations may include verifying locations for assembling parts, verifying locations for installation plans, performing inspections on parts that have been installed, and other suitable operations.

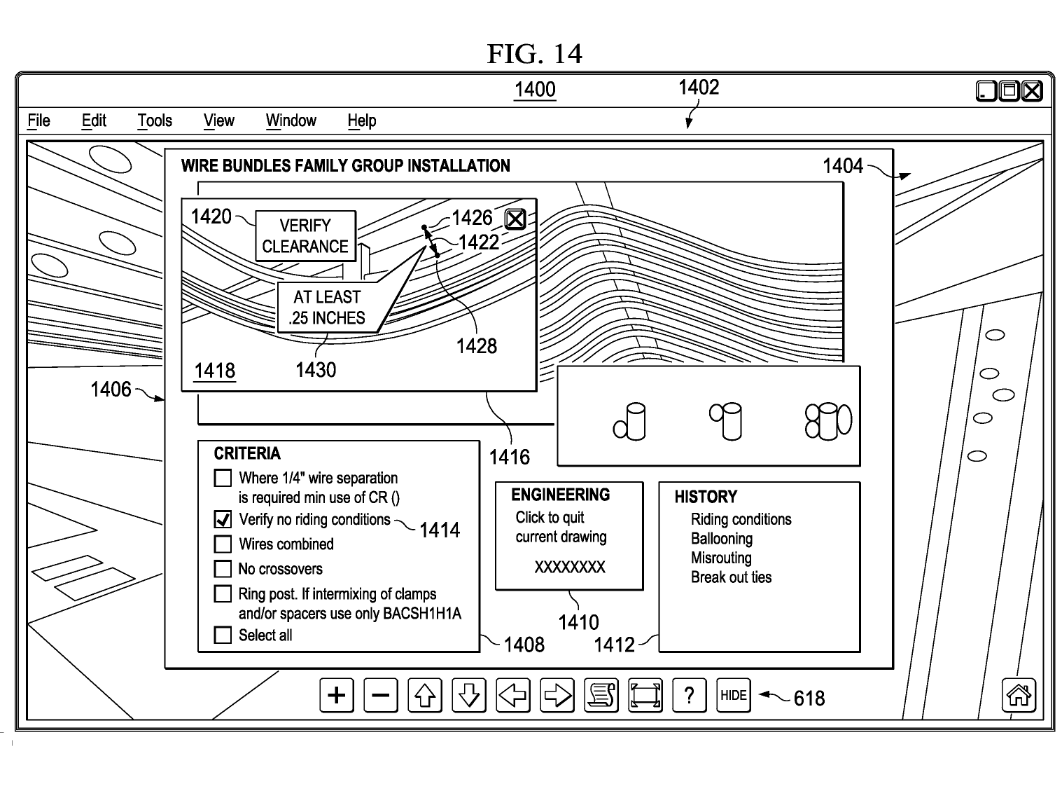

Turning next to FIG. 14, an illustration of a display of a portion of an aircraft is depicted in accordance with an illustrative embodiment. In this example, graphical user interface 1400 is an example of another implementation for graphical user interface 132 shown in block form in FIG. 1.

In this example, display 1402 is shown in graphical user interface 1400. Display 1402 includes image 1404 of the interior of the aircraft. In this example, popup window 1406 displays information relating to an installation plan for wire bundles in the aircraft. Section 1408 shows a checklist for a wire bundle, section 1410 has links to engineering drawings, and section 1412 has a history of issues relating to the installation plan.

In this depicted example, the selection of item 1414 from the checklist in section 1408 results in popup window 1416 being displayed in display 1402. Popup window 1416 provides additional information about the installation plan regarding item 1414. As depicted, popup window 1416 includes image 1418 of a wiring bundle in callout 1420 and arrow 1422 as visual aids. Callout 1420 directs the operator to verify a clearance and arrow 1422 shows where to make the measurement.

In this illustrative example, arrow 1422 is an example of a callout that may also be used to point out the distance that should be verified in addition to the instruction for item 1414 in the checklist. For example, the operator may select point 1426 and point 1428 on either side of arrow 1422. The selection of point 1426 and point 1428 may provide callout 1430 which states that a separation of at least 0.25 inches is needed.

In this illustrative example, the selection of point 1426 and point 1428 results in an identification of the distance between those two points. This identification may be made for any two points in image 1404 when a second image in addition to image 1404 is present. In this example, the second image is taken from an offset of image 1404. These two images form a set of images that may be used as a stereographic display allowing for point-to-point measurements to be made between points within image 1404. In some illustrative examples, only image 1404 may be displayed and the second image is used to calculate the distance between the points.

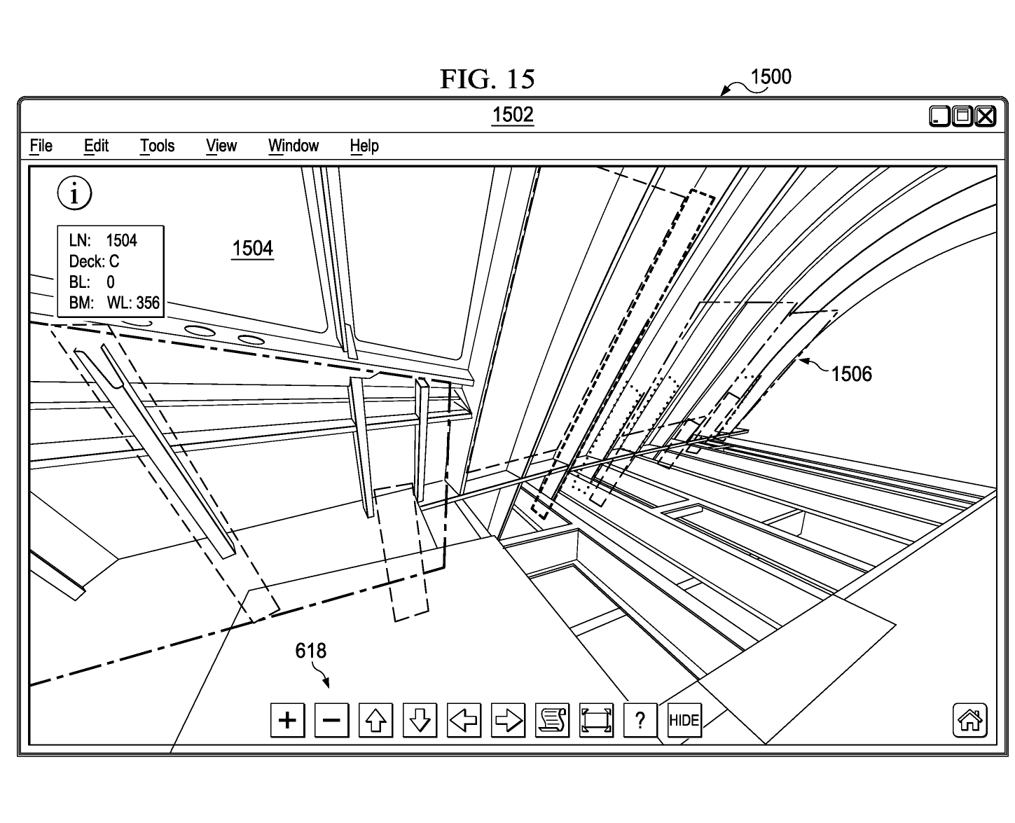

Turning next to FIG. 15, an illustration of a display of a portion of an aircraft is depicted in accordance with an illustrative embodiment. In this example, graphical user interface 1500 is an example of another implementation for graphical user interface 132 shown in block form in FIG. 1.

In this example, display 1502 displayed in graphical user interface 1500 includes image 1504 of a portion of an interior of an aircraft. In this example, hot spots for installation plans are displayed using graphical overlays 1506 in the form of color and icons.

In another example, image registration may be performed. In image registration, an image generated by a camera in a mobile data processing system, the portion of the interior of the aircraft is compared to images of the aircraft stored in an image database. Image comparison is used to identify an image, such as image 1504, in the image database that corresponds to the image generated by a camera in the mobile data processing system. When image 1504 in the image database is identified, image 1504 may be overlaid with the image generated by the camera as part of forming display 1502.

Differences between image 1504 and the image generated by the camera may be seen by the viewer. These differences may be emphasized by modifying at least one of image 1504 or the image generated by the camera. The modification may be, for example, displaying the image generated by the camera as a grayed-out image. In other words, the image generated by the camera may be displayed using shades of gray while image 1504 is displayed using color. In other illustrative examples, differences may be identified and emphasized using graphical indicators such as color, flashing pixels, or other suitable graphical indicators.

Graphical overlays 1506 may then be displayed on these two images. If the viewer sees differences between image 1504 and the image generated by the camera in an area with the graphical overlay, the viewer may obtain more information by selecting the graphical overlay to obtain information about an installation plan for that area.

In this manner, a viewer of display 1502 may visualize additional information through the use of image 1502 and the image generated by the camera. For example, if image 1502 is from a different phase of assembly from the image generated by the camera, these differences may be emphasized and seen in display 1502. Graphical overlays 1506 graphically indicate where the installation plans are present in display 1502.

As another illustrative example, overlaying image 1502 with the image from the camera may be used to identify differences in installation. For example, image 1502 may illustrate an assembly of parts assembled in a desired configuration. The image generated by the camera may be overlaid on image 1502 such that a viewer may visualize whether the actual installation of the parts are in the desired configuration.

The illustrations of the graphical user interfaces in FIG. 5-15 are shown to illustrate a few of implementations for graphical user interface 132 and may show display 128 in FIG. 1. These examples are not meant to limit the manner in which other illustrative embodiments may be depicted. For example, the displays shown in the figures are for an interior or an aircraft. Other illustrative examples may show an exterior of an aircraft. In yet another illustrative example, the information may be displayed in tool tips, additional sections in the original popup window, or other constructs in addition to or in place of the popup windows.

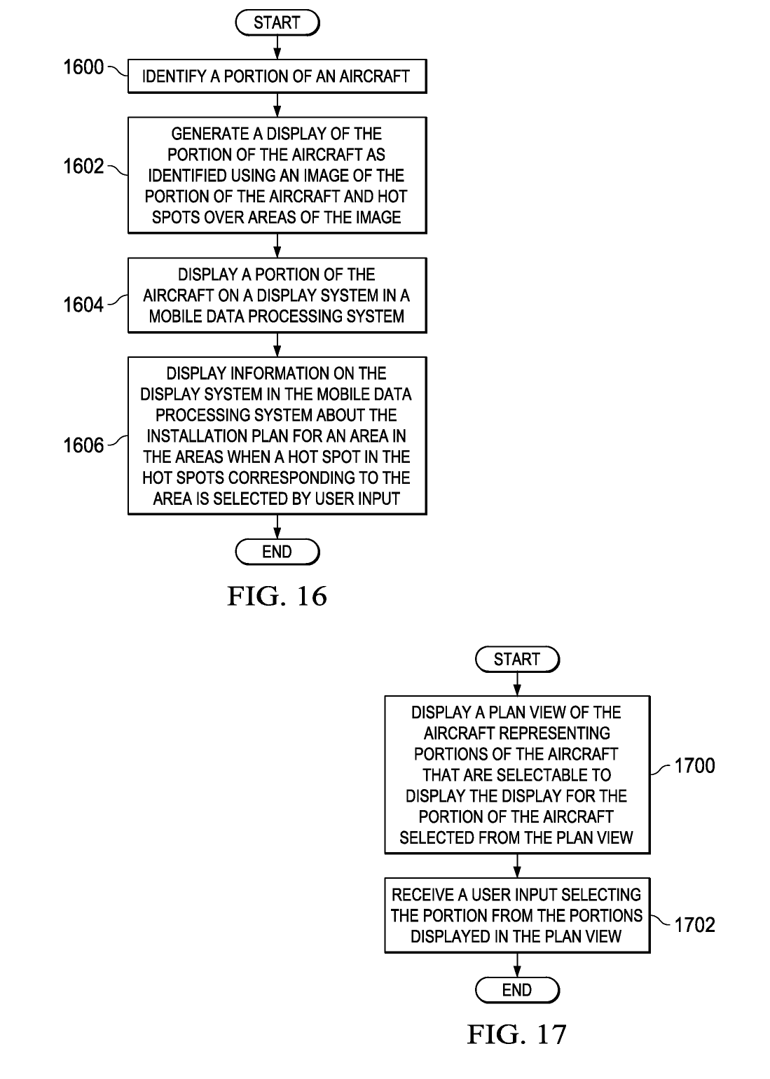

With reference to FIG. 16, an illustration of a flowchart of a process for a method for providing a visual aid in assembling an aircraft is depicted in accordance with an illustrative embodiment. The process illustrated in FIG. 16 may be implemented in aircraft manufacturing environment 102 in FIG. 1 to perform assembly operations 106. The processes may be implemented using at least one of visualizer 114 or mobile data processing system 120 in FIG. 1.

The process begins by identifying a portion of an aircraft (operation 1600). The portion may be identified in a number of different ways. For example, the portion may be identified from at least one of a user input selected portion or a position of a mobile data processing system relative to the aircraft. The process then generates a display of the portion of the aircraft as identified using an image of the portion of the aircraft and hot spots over areas of the image (operation 1602). In operation 1602, the hot spots may be displayed using overlays that are displayed on the areas, or in some other manner to draw attention to the areas to which the hot spots represent particular installation plans.

The process displays a portion of the aircraft on a display system in a mobile data processing system (operation 1604). In operation 1604, the display on the display system comprises an image of the portion of the aircraft and the hot spots over the areas of the image. The hot spots correspond to the installation plans for the areas over which the hot spots are located and the hot spots are selectable by user input.

The process then displays information on the display system in the mobile data processing system about the installation plan for an area in the areas when a hot spot in the hot spots corresponding to the area is selected by user input (operation 1606), with the process terminating thereafter. The display of the information provides a visual aid that enables performance of an assembly operation in the area selected. In operation 1606, the displaying of the display system may include, for example, displaying at least one of parts to provide the visual aid as a guide to locate the parts installed during assembly of the aircraft, instructions for assembling a group of parts, a checklist of the parts, or a group of links that are selectable to display at least one of an engineering drawing, a computer aided design model, or inspection data.

With the visual aid, an operator may perform the assembly operation in the area using the information about the installation plan displayed for the area selected by the user input. The assembly operation is selected from one of an assembly of parts and an inspection of an assembly of parts.

With reference now to FIG. 17, an illustration of a flowchart of a process for identifying a portion of an aircraft is depicted in accordance with an illustrative embodiment. The process illustrated in FIG. 17 is an example of one implementation for operation 1600 in FIG. 16.

The process begins by displaying a plan view of the aircraft representing portions of the aircraft that are selectable to display the display for the portion of the aircraft selected from the plan view (operation 1700). The process then receives a user input selecting the portion from the portions displayed in the plan view (operation 1702), with the process terminating thereafter.

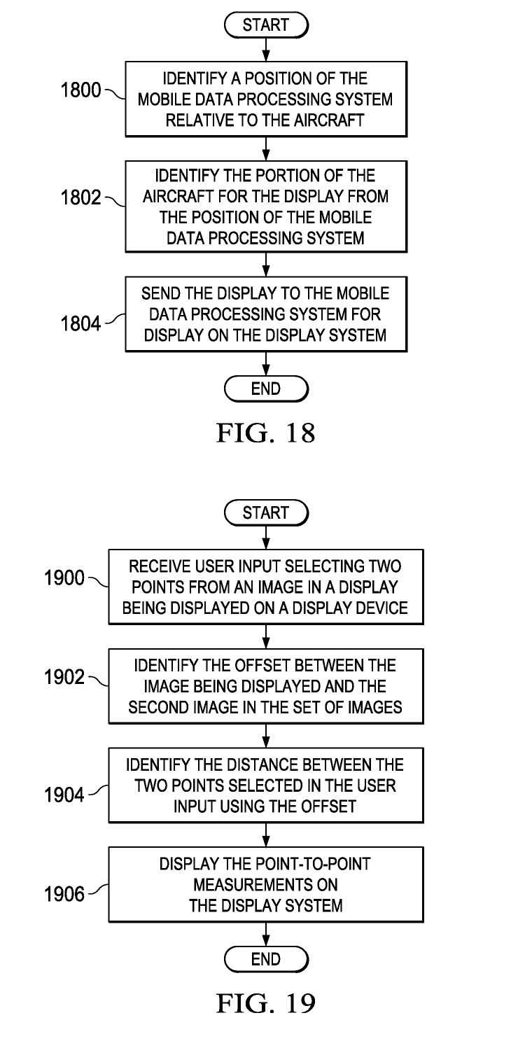

With reference now to FIG. 18, another illustration of a flowchart of a process for identifying a portion of an aircraft is depicted in accordance with an illustrative embodiment. The process illustrated in FIG. 18 is another example of an implementation for operation 1600 in FIG. 16.

The process begins by identifying a position of the mobile data processing system relative to the aircraft (operation 1800). The process then identifies the portion of the aircraft for the display from the position of the mobile data processing system (operation 1802). The position of the mobile data processing system may be identified through the camera of the mobile data processing system at a position in the aircraft with images for different portions of the aircraft. Alternatively, other positioning systems such as a wireless positioning system, a dead reckoning system, or other currently available techniques for identifying positions may be used.

With the portion identified, the display of the portion of the aircraft as identified using this process may be made using the image for the portion of the aircraft and the hot spots over areas of the image based on the position of the mobile data processing system as described in operation 1602 in FIG. 16. The display may then be sent to the mobile data processing system for display on the display system (operation 1804), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

With reference next to FIG. 19, an illustration of a flowchart of a process for generating point-to-point measurements is depicted in accordance with an illustrative embodiment. The process illustrated in FIG. 19 may be implemented in computer system 118. For example, the process may be implemented using mobile data processing system 120 in visualizer 114.

The process begins by receiving user input selecting two points from an image in a display being displayed on a display device (operation 1900). In this illustrative example, the user input may be made to a touchscreen in mobile data processing system 120. The image being displayed may be displayed along with another second image taken from an offset position. In other illustrative examples, only one image may be displayed and the second image in the set is used to calculate distances between selected points.

The process then identifies the offset between the image being displayed and the second image in the set of images (operation 1902). The process then identifies the distance between the two points selected in the user input using the offset (operation 1904). Operation 1904 may include scaling pixels in images using computer-aided design models for the object represented in the pixelated images. As a result, selections of pixels in different locations may be used in identifying the distance between those pixels. The process displays the point-to-point measurements on the display system (operation 1906), with the process terminating thereafter.

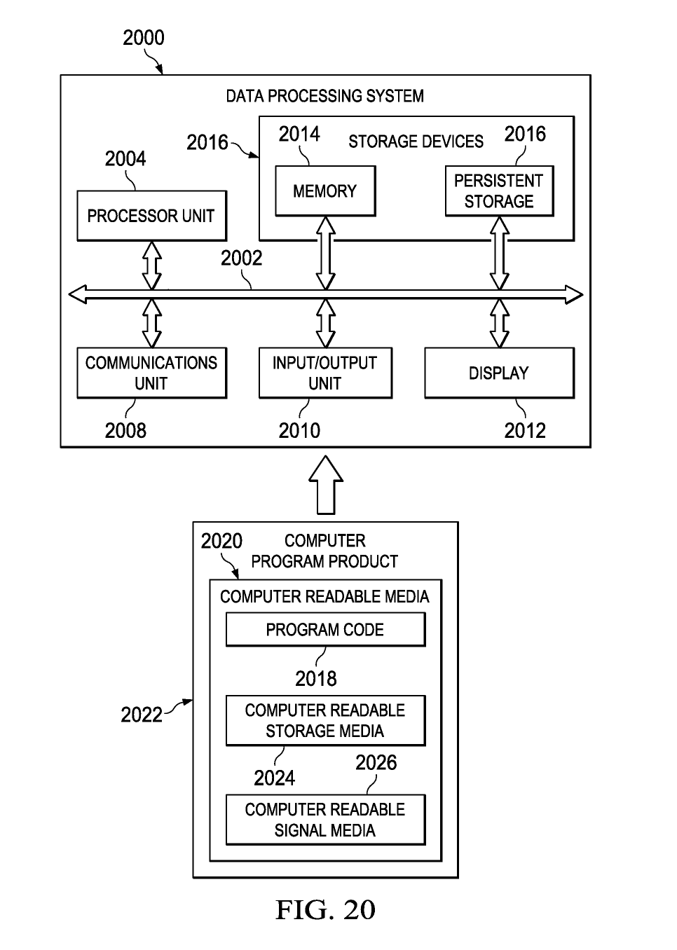

Turning now to FIG. 20, an illustration of a data processing system in the form of a block diagram is depicted in accordance with an illustrative embodiment. Data processing system 2000 may be used to implement one or more computers in computer system 118 in FIG. 1. For example, data processing system 2000 may be used to implement mobile data processing system 120 in FIG. 1. As depicted, data processing system 2000 includes communications framework 2002, which provides communications between processor unit 2004, storage devices 2006, communications unit 2008, input/output unit 2010, and display 2012. In some cases, communications framework 2002 may be implemented as a bus system.

Processor unit 2004 is configured to execute instructions for software to perform a number of operations. Processor unit 2004 may comprise at least one of a number of processors, a multi-processor core, or some other type of processor, depending on the implementation. In some cases, processor unit 2004 may take the form of a hardware unit, such as a circuit system, an application specific integrated circuit (ASIC), a programmable logic device, or some other suitable type of hardware unit.

Instructions for at least one of the operating system, applications, or programs run by processor unit 2004 may be located in storage devices 2006. Storage devices 2006 may be in communication with processor unit 2004 through communications framework 2002. As used herein, a storage device, also referred to as a computer readable storage device, is any piece of hardware capable of storing information on at least one of a temporary or permanent basis. This information may include, but is not limited to, data, program code, and other information.

Memory 2014 and persistent storage 2016 are examples of storage devices 2006. Memory 2014 may take the form of, for example, a random access memory or some type of volatile or non-volatile storage device. Persistent storage 2016 may comprise any number of components or devices. For example, persistent storage 2016 may comprise a hard drive, a flash memory, a rewritable optical disk, a rewritable magnetic tape, or some combination of the above. The media used by persistent storage 2016 may or may not be removable.

Communications unit 2008 allows data processing system 2000 to communicate with other data processing systems and devices. Communications unit 2008 may provide communications using physical communications links, wireless communications links, or some combination thereof.

Input/output unit 2010 allows input to be received from and output to be sent to other devices connected to data processing system 2000. For example, input/output unit 2010 may allow user input to be received through at least one of a keyboard, a mouse, or some other type of input device. As another example, input/output unit 2010 may allow output to be sent to a printer connected to data processing system 2000.

Display 2012 is configured to display information to a user. Display 2012 may comprise, for example, without limitation, a monitor, a touch screen, a laser display, a holographic display, a virtual display device, or some other type of display device.

In this illustrative example, the processes of the different illustrative embodiments may be performed by processor unit 2004 using computer-implemented instructions. These instructions may be referred to as program code, computer usable program code, or computer readable program code and may be read and executed by one or more processors in processor unit 2004.

In these examples, program code 2018 is located in a functional form on computer readable media 2020, which is selectively removable, and may be loaded onto or transferred to data processing system 2000 for execution by processor unit 2004. Program code 2018 and computer readable media 2020 together form computer program product 2022. In this illustrative example, computer readable media 2020 may be computer readable storage media 2024 or computer readable signal media 2026.

Computer readable storage media 2024 is a physical or tangible storage device used to store program code 2018 rather than a medium that propagates or transmits program code 2018. Computer readable storage media 2024 may be, for example, without limitation, an optical or magnetic disk or a persistent storage device that is connected to data processing system 2000.

Alternatively, program code 2018 may be transferred to data processing system 2000 using computer readable signal media 2026. Computer readable signal media 2026 may be, for example, a propagated data signal containing program code 2018. This data signal may be using at least one of an electromagnetic signal, an optical signal, or some other type of signal that can be transmitted over physical communications links, wireless communications links, or both.

The illustration of data processing system 2000 in FIG. 20 is not meant to provide architectural limitations to the manner in which the illustrative embodiments may be implemented. The different illustrative embodiments may be implemented in a data processing system that includes components in addition to or in place of those illustrated for data processing system 2000. Further, components shown in FIG. 20 may be varied from the illustrative examples shown.

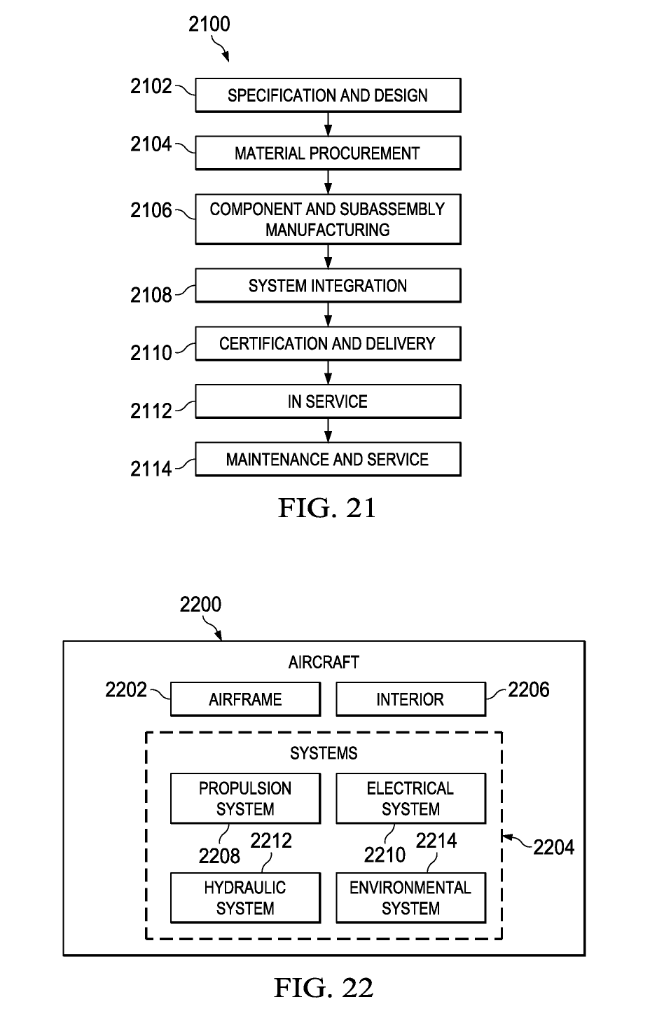

The illustrative embodiments of the disclosure may be described in the context of aircraft manufacturing and service method 2100 as shown in FIG. 21 and aircraft 2200 as shown in FIG. 22. Turning first to FIG. 21, an illustration of an aircraft manufacturing and service method is depicted in the form of a block diagram in accordance with an illustrative embodiment. During pre-production, aircraft manufacturing and service method 2100 may include specification and design 2102 of aircraft 2200 in FIG. 22 and material procurement 2104.

During production, component and subassembly manufacturing 2106 and system integration 2108 of aircraft 2200 in FIG. 22 takes place. Thereafter, aircraft 2200 in FIG. 22 may go through certification and delivery 2110 in order to be placed in service 2112. While in service 2112 by a customer, aircraft 2200 in FIG. 22 is scheduled for routine maintenance and service 2114, which may include modification, reconfiguration, refurbishment, and other maintenance or service.

Each of the processes of aircraft manufacturing and service method 2100 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 22, an illustration of an aircraft is depicted in the form of a block diagram in which an illustrative embodiment may be implemented. In this example, aircraft 2200 is produced by aircraft manufacturing and service method 2100 in FIG. 21 and may include airframe 2202 with plurality of systems 2204 and interior 2206. Examples of systems 2204 include one or more of propulsion system 2208, electrical system 2210, hydraulic system 2212, and environmental system 2214. Any number of other systems may be included. Although an aerospace example is shown, different illustrative embodiments may be applied to other industries, such as the automotive industry. Apparatuses and methods embodied herein may be employed during at least one of the stages of aircraft manufacturing and service method 2100 in FIG. 21.

In one illustrative example, components or subassemblies produced in component and subassembly manufacturing 2106 in FIG. 21 may be fabricated or manufactured in a manner similar to components or subassemblies produced while aircraft 2200 is in service 2112 in FIG. 21. As yet another example, one or more apparatus embodiments, method embodiments, or a combination thereof may be utilized during production stages, such as component and subassembly manufacturing 2106 and system integration 2108 in FIG. 21. One or more apparatus embodiments, method embodiments, or a combination thereof may be utilized while aircraft 2200 is in service 2112, during maintenance and service 2114 in FIG. 21, or both.

For example, visualizer 114 and mobile data processing system 120 may be used to perform assembly operations during system integration 2108. Additionally, an illustrative embodiment also may be used during maintenance and service 2114 in a maintenance environment to perform assembly operations that may occur during maintenance. For example, assembly operations may be performed to replace parts, install new parts, and perform other operations. These assembly operations may be performed for normal maintenance, refurbishment, upgrades, and other types of maintenance that may be performed on aircraft 2200 during maintenance and service 2114. The use of a number of the different illustrative embodiments may substantially expedite the assembly of aircraft 2200, reduce the cost of aircraft 2200, or both expedite the assembly of aircraft 2200 and reduce the cost of aircraft 2200.

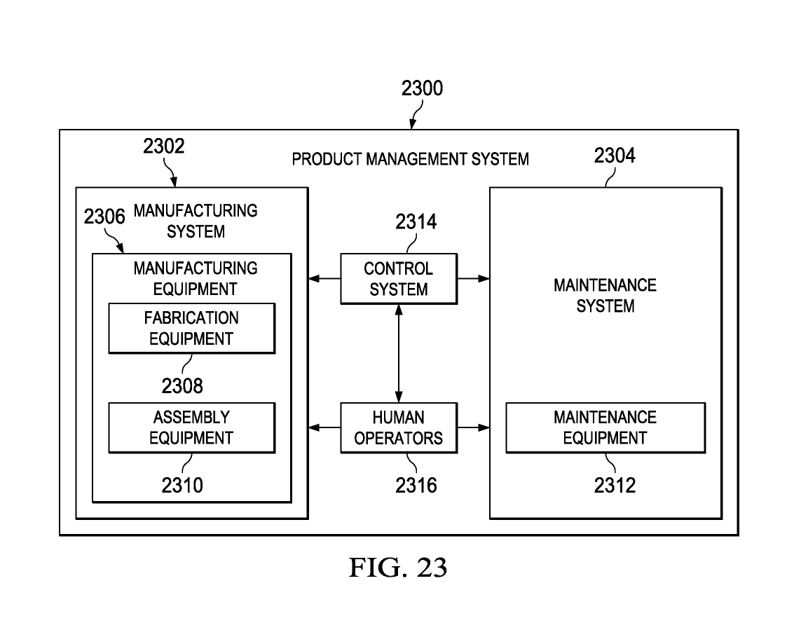

Turning now to FIG. 23, an illustration of a block diagram of a product management system is depicted in accordance with an illustrative embodiment. Product management system 2300 is a physical hardware system. In this illustrative example, product management system 2300 may include at least one of manufacturing system 2302 or maintenance system 2304. When used to manage a product such as an aircraft, product management system 2300 may be referred to as an aircraft management system.

Manufacturing system 2302 is configured to manufacture products, such as aircraft 2200 in FIG. 22. As depicted, manufacturing system 2302 includes manufacturing equipment 2306. Manufacturing equipment 2306 includes at least one of fabrication equipment 2308 or assembly equipment 2310.

Fabrication equipment 2308 is equipment that may be used to fabricate components for parts used to form aircraft 2200. For example, fabrication equipment 2308 may include machines and tools. These machines and tools may be at least one of a drill, a hydraulic press, a furnace, a mold, a composite tape laying machine, a vacuum system, a lathe, or other suitable types of equipment. Fabrication equipment 2308 may be used to fabricate at least one of metal parts, composite parts, semiconductors, circuits, fasteners, ribs, skin panels, spars, antennas, or other suitable types of parts.

Assembly equipment 2310 is equipment used to assemble parts to form aircraft 2200. In particular, assembly equipment 2310 may be used to assemble components and parts to form aircraft 2200. Assembly equipment 2310 also may include machines and tools. These machines and tools may be at least one of a robotic arm, a crawler, a faster installation system, a rail-based drilling system, a robot, or other suitable types of equipment. Assembly equipment 2310 may be used to assemble parts such as seats, horizontal stabilizers, wings, engines, engine housings, landing gear systems, and other parts for aircraft 2200.

In this illustrative example, maintenance system 2304 includes maintenance equipment 2312. Maintenance equipment 2312 may include any equipment needed to perform maintenance on aircraft 2200. This maintenance may include tools for performing different operations on parts on aircraft 2200. These operations may include at least one of disassembling parts, refurbishing parts, inspecting parts, reworking parts, manufacturing placement parts, or other operations for performing maintenance on aircraft 2200. These operations may be for routine maintenance, inspections, upgrades, refurbishment, or other types of maintenance operations.

In the illustrative example, maintenance equipment 2312 may include ultrasonic inspection devices, x-ray imaging systems, vision systems, drills, crawlers, and other suitable device. In some cases, maintenance equipment 2312 may include fabrication equipment 2308, assembly equipment 2310, or both to produce and assemble parts that may be needed for maintenance.

Product management system 2300 also includes control system 2314. Control system 2314 is a hardware system and may also include software or other types of components. Control system 2314 is configured to control the operation of at least one of manufacturing system 2302 or maintenance system 2304. In particular, control system 2314 may control the operation of at least one of fabrication equipment 2308, assembly equipment 2310, or maintenance equipment 2312.

The hardware in control system 2314 may be using hardware that may include computers, circuits, networks, and other types of equipment. The control may take the form of direct control of manufacturing equipment 2306. For example, robots, computer-controlled machines, and other equipment may be controlled by control system 2314. In other illustrative examples, control system 2314 may manage operations performed by human operators 2316 in manufacturing or performing maintenance on aircraft 2200. For example, control system 2314 may assign tasks, provide instructions, display models, or perform other operations to manage operations performed by human operators 2316.

In these illustrative examples, visualizer 114 from FIG. 1 may be implemented in control system 2314 to manage at least one of the manufacturing or maintenance of aircraft 2200 in FIG. 22. In particular, visualizer 114 may be used to provide visualizations to human operators 2316 in a manner that increases efficiency in managing at least one of manufacturing or maintenance of aircraft 2200 in FIG. 22.

In the different illustrative examples, human operators 2316 may operate or interact with at least one of manufacturing equipment 2306, maintenance equipment 2312, or control system 2314. This interaction may be performed to manufacture aircraft 2200. In these illustrative examples, a mobile data processing system, such as mobile data processing system 120, may be part of at least one of manufacturing equipment 2306 or maintenance equipment 2312 in used to perform manufacturing or maintenance operations.

Of course, product management system 2300 may be configured to manage other products other than aircraft 2200. Although product management system 2300 has been described with respect to manufacturing in the aerospace industry, product management system 2300 may be configured to manage products for other industries. For example, product management system 2300 may be configured to manufacture products for the automotive industry as well as any other suitable industries.

Thus, one or more illustrative embodiments may be used to provide the visual aids to operators performing assembly operations for an aircraft. In one illustrative example, a visualizer and a mobile data processing system may be used to provide a visual aid to an operator performing the assembly operation. This visual aid may be displayed on a display system in the mobile data processing system while the operator is at a location relative to the aircraft. For example, the operator may be performing the assembly operation on the exterior of the aircraft or in the interior of the aircraft. With an illustrative embodiment, the operator may obtain the visualization using the visual aid of where and how the assembly operation should be performed for a particular installation plan. For example, an image of a portion of an aircraft may be displayed that allows the operator to traverse the image to locate where the assembly operation should be performed. In these illustrative examples, hot spots with graphical overlays representing installation plans are present. The graphical overlays are displayed over locations where the assembly operation should be performed.

The graphical overlays provide the operator the visualization of where in the aircraft a particular assembly operation should be performed for particular installation plans. In this manner, one or more illustrative embodiments overcome issues with the use of paper engineering drawings and checklists. With the use of images in a display, the amount of processing resources may be reduced to generate a display for the human operator on a mobile data processing system as compared to generating a display with the model of the entire aircraft.

Further, in an illustrative example, a model of a particular part or assembly of parts may be displayed using the mobile data processing system. This model is smaller in size than the model of the entire aircraft, allowing for the use of fewer resources to provide a visualization.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for providing a visual aid in assembling an aircraft, the method comprising:
displaying a display for a portion of the aircraft on a display system in a mobile data processing system, wherein the display on the display system comprises an image of the portion of the aircraft and hot spots over areas of the image, wherein the hot spots correspond to installation plans for the areas over which the hot spots are located and the hot spots are selectable by user input; and
displaying information on the display system in the mobile data processing system about an installation plan for an area in the areas when a hot spot in the hot spots corresponding to the area is selected by the user input, wherein the display of the information on the display system provides the visual aid that enables performance of an assembly operation in the area selected.

2. The method of claim 1 further comprising:
identifying the portion of the aircraft; and
generating the display of the portion of the aircraft as identified using the image of the portion of the aircraft and the hot spots over the areas of the image.

3. The method of claim 2, wherein generating the display of the portion of the aircraft as identified using the image of the portion of the aircraft and the hot spots over the areas of the image comprises:
generating the display of the portion of the aircraft as identified using the image of the portion of the aircraft and the hot spots over the areas of the image at a computer; and
sending the display to the mobile data processing system.

4. The method of claim 2, wherein identifying the portion of the aircraft comprises:
displaying a plan view of the aircraft representing portions of the aircraft that are selectable to display the display for the portion of the aircraft selected from the plan view; and
receiving the user input selecting the portion from the portions displayed in the plan view.

5. The method of claim 3 further comprising:
displaying phases of assembly for the aircraft that are selectable such that the image displayed for the portion selected corresponds to a phase of assembly selected.

6. The method of claim 1 further comprising:
identifying a position of the mobile data processing system relative to the aircraft, wherein generating the display of the portion of the aircraft as identified using the image of the portion of the aircraft and the hot spots over the areas of the image comprises:
generating the display of the portion of the aircraft as identified using the image of the portion of the aircraft and the hot spots over the areas of the image based on the position of the mobile data processing system; and further comprising:
sending the display to the mobile data processing system.

7. The method of claim 1, wherein the displaying step comprises:
displaying at least one of parts to provide the visual aid as a guide to locate the parts installed during assembly of the aircraft; instructions for assembling a group of parts, a checklist of the parts; or a group of links that are selectable to display at least one of an engineering drawing, a computer aided design model, or inspection data.

8. The method of claim 1, wherein the hot spot in the hot spots is selected from the user input comprising at least one of a pointer hovering over the hot spot, a rollover, or a mouse click when the pointer is over the hot spot and wherein the portion of the aircraft is selected from one of an interior of the aircraft or an exterior of the aircraft.

9. The method of claim 1, wherein the hot spots are displayed using graphical overlays on the areas where assembly is planned based on the installation plans.

10. An apparatus comprising:
a visualizer that displays a display for a portion of an aircraft on a display system in a mobile data processing system, wherein the display on the display system comprises an image of the portion of the aircraft and hot spots over areas of the image, wherein the hot spots correspond to installation plans for the areas over which the hot spots are located and the hot spots are selectable by user input; and displays information on the display system in the mobile data processing system about an installation plan for an area in the areas when a hot spot in the hot spots corresponding to the area is selected by the user input, wherein the display of the information on the display system provides a visual aid that enables performance of an assembly operation in the area selected.

11. The apparatus of claim 10, wherein the visualizer identifies the portion of the aircraft; and generates the display of the portion of the aircraft as identified using the image of the portion of the aircraft and the hot spots over the areas of the image.

12. The apparatus of claim 11, wherein in generating the display, the visualizer generates the display of the portion of the aircraft as identified using the image of the portion of the aircraft and the hot spots over the areas of the image at a computer and sends the display to the mobile data processing system.

13. The apparatus of claim 11, wherein in identifying the portion of the aircraft, the visualizer displays a plan view of the aircraft representing portions of the aircraft that are selectable to display the display for the portion of the aircraft selected from the plan view; and receives the user input selecting the portion from the portions displayed in the plan view.

14. The apparatus of claim 11, wherein in identifying the portion of the aircraft, the visualizer identifies a position of the mobile data processing system relative to the aircraft, wherein in generating the display, the visualizer generates the display of the portion of the aircraft as identified using the image of the portion of the aircraft and the hot spots over the areas of the image based on the position of the mobile data processing system; and sends the display to the mobile data processing system.

15. The apparatus of claim 12, wherein the visualizer displays phases of assembly for the aircraft that are selectable such that the image displayed for the portion selected corresponds to a phase of assembly selected.

16. The apparatus of claim 10, wherein in displaying the display, the visualizer displays at least one of parts to provide the visual aid as a guide to locate the parts installed during assembly of the aircraft; a checklist of the parts; or a group of links that are selectable to display at least one of an engineering drawing, a computer aided design model, or inspection data.

17. The apparatus of claim 10, wherein the hot spot in the hot spots selected from the user input comprises at least one of a pointer hovering over the hot spot, a rollover, or a mouse click when the pointer is over the hot spot.

18. The apparatus of claim 10, wherein the hot spots are displayed using graphical overlays on the areas where assembly is planned based on the installation plans.

19. The apparatus of claim 10, wherein the image is formed from combining photographic images with overlapping fields of view for the portion of the aircraft.

20. An aircraft management system comprising:
a manufacturing system; and
a control system that displays a display for a portion of an aircraft on a display system in a mobile data processing system, wherein the display on the display system comprises an image of the portion of the aircraft and hot spots over areas of the image, wherein the hot spots correspond to installation plans for the areas over which the hot spots are located and the hot spots are selectable by user input; and displays information on the display system in the mobile data processing system about an installation plan for an area in the areas when a hot spot in the hot spots corresponding to the area is selected by the user input, wherein the display of the information provides a visual aid that enables performance of an assembly operation in the area selected using the manufacturing system.
